(19) United States
(12) Patent Application Publication
(10) Pub. No.: US 2026/0295933 A1
(43) Pub. Date: Oct. 1, 2026

(54) FERROMAGNETIC MATERIAL AND USES THEREOF

(71) Applicant: MULTI-SCALE MEDICAL ROBOTICS CENTER LIMITED, Hong Kong (CN)

(72) Inventors: Li ZHANG, Hong Kong (CN); Neng XIA, Hong Kong (CN); Dongdong JIN, Hong Kong (CN)

(21) Appl. No.: 19/630,091

(22) Filed: Mar. 26, 2026

Related U.S. Application Data
(60) Provisional application No. 63/777,731, filed on Mar. 26, 2025.

(51) Int. Cl. B29C 64/124; B29K 105/00; B29K 105/16; B29K 509/00; B33Y 10/00; B33Y 40/20; B33Y 70/10

(52) U.S. Cl. CPC B29C 64/124; B33Y 10/00; B33Y 40/20; B33Y 70/10; B29K 2105/0061; B29K 2105/16; B29K 2509/00; B29K 2995/0008

(57) ABSTRACT

This invention provides a ferromagnetic material. In one embodiment, said ferromagnetic material comprises: a) A hydrogel network comprising a pre-determined crosslinking density such that said hydrogel network can morph between a normal state and a second state, wherein said second state comprises a pre-determined shape resulting from said pre-determined crosslinking density; and b) Ferromagnetic particles entangled in said hydrogel network, wherein said ferromagnetic particles form uniformly oriented ferromagnetic domains in said second state; wherein said ferromagnetic material morphs from said normal state to said second state due to dipolar interaction when subjected to a suitable magnetic field.

### FIELD OF THE INVENTION

The present invention relates to ferromagnetic materials, particularly the inverse programming of ferromagnetic domains for 3D curved surfaces of soft materials.

### BACKGROUND OF THE INVENTION

Reconfigurable 3D surfaces found in nature are inspiring for advancing technologies in smart materials, soft robotics and precision medicine. Although ferromagnetic soft materials enable the dynamic and reversible regulation of 3D shape transformation, challenges lie in the programming of ferromagnetic domains to design 3D curved surfaces, because previous methods based on optimization models or machine learning incur a computational burden. Here the template-free, inverse programming of hard-magnetic domains embedded in a soft material is reported. This method can trigger shape morphing into 3D curved surfaces under the actuation of a magnetic field. A ferromagnetic hydrogel resin and photodosage-based printing method are developed to prepare a ferromagnetic soft material with controllable distribution of crosslinking densities, resulting in heterogeneous swelling upon solvent stimulation to transform the soft material into a designed 3D morphological shape. By applying a strong pulsed magnetic field followed by recovery to the initial 2D configuration, the ferromagnetic soft material is programmed with a 3D magnetization profile. An inverse design algorithm is used to flatten the 3D surface into a 2D pattern with programmed crosslinking densities, serving as the exposure guidance for photodosage-based printing of the ferromagnetic soft material.

Soft tissues that can dynamically reconfigure into three-dimensional (3D) curved surfaces are ubiquitous in living organisms and play a critical role in vital activities, including locomotion, camouflage, object manipulation and physiological regulation¹⁻⁵. These free-form surface morphologies serve as inspiration for the advancement of soft materials and functional systems across scales (for example, from macroscale flying devices to micro- or nanoscale sensors and actuators⁶⁻¹⁴), contributing to the optimization of their locomotion performance, adaptability to complex environments and multifunctionality integration^{9,15-22}. Although two-dimensional (2D)-to-3D transformations of soft materials have been investigated^{3,23}, achieving reversible and precise control over complex 3D curved surfaces remains formidable, owing to the challenges in analysing nonlinear mechanical properties of active soft materials and the numerous sophisticated deformation configurations that soft materials can exhibit in response to stimuli²⁴⁻²⁷.

To achieve biomimetic morphological transformations, scientists and engineers have developed various smart materials and actuation strategies utilizing spatiotemporal geometry, stiffness, strain and stress engineering in thin films^{3,6,28-30}. Among these, magnetic actuation of ferromagnetic soft materials stands out with unique advantages, including a fast actuation rate, remote response mode and high-degree-of-freedom programmability³¹⁻³⁶. Through configuring the positions and orientations of ferromagnetic domains throughout the soft material matrix (that is, magnetization profile programming), a variety of dynamic 3D morphed shapes have been realized upon the application of external magnetic fields. While template-assisted magnetization emerges as the most exploited approach^{33,37,38}, the introduction of additive manufacturing and microassembly techniques has further expanded the design freedom of magnetization profiles^{9,18,19,31,37,39-46} (Supplementary Table 1). However, achieving complex shapes of ferromagnetic soft materials with target 3D curved surfaces has still been a challenge because the traditional intuition-guided design methods face difficulties in determining the ferromagnetic domain parameters amid increasing magnetic dipolar interaction complexities and high computational costs.

Here, a template-free programming and inverse design strategy for the magnetization profiles of ferromagnetic soft films is proposed, enabling dynamic and reversible transformation into 3D curved surfaces under the actuation of a magnetic field. A solvent-responsive hydrogel resin doped with hard-magnetic microparticles is prepared for photocuring and develop a photodosage-based printing method to actively tune the local crosslinking density of the hydrogel network by adjusting photoexposure time. Modulating crosslinking density induces locally inhomogeneous swelling of hydrogel when immersed in a specific solvent and temporarily transforms the prepared 2D ferromagnetic soft film into a 3D morphological shape. By applying a pulsed magnetic field H (~2.5 T), the deformed ferromagnetic soft material becomes magnetized, resulting in a non-zero net magnetization. Subsequently, the ferromagnetic soft material is recovered to its initial flat shape upon being removed from the solvent. During this process, the transformation of the hydrogel network modulates the magnetization directions in different regions of the ferromagnetic soft material, providing a template-free strategy for programming 3D magnetization profiles. An inverse design algorithm is further developed to guide the construction of ferromagnetic soft materials towards complex target 3D surfaces. The deformation relationship between the 3D and 2D surfaces determines a specific distribution of crosslinking density over the ferromagnetic soft film, which can be realized by the developed photodosage-based printing method. In this manner, a 3D-distributed magnetization profile is programmed into the 2D ferromagnetic film, enabling the accurate reproduction of the target 3D surface under magnetic actuation. This template-free programming and inverse design strategy transforms the high-degree-of-freedom and difficult-to-solve problem of 3D magnetization profile programming into a simple and solvable question regarding the crosslinking density distribution throughout 2D ferromagnetic soft materials, which notably reduces the computational complexity and burden. Various 3D curved shapes and Gaussian surfaces such as a human face are replicated at millimetre scale, demonstrating promising potentials in information storage, biomimetic soft robots and biomedical fields.

### SUMMARY OF THE INVENTION

This invention provides a ferromagnetic material. In one embodiment, said ferromagnetic material comprises: a) A hydrogel network comprising a pre-determined crosslinking density such that said hydrogel network can morph between a normal state and a second state, wherein said second state comprises a pre-determined shape resulting from said pre-determined crosslinking density; and b) Ferromagnetic particles entangled in said hydrogel network, wherein said ferromagnetic particles form uniformly oriented ferromagnetic domains in said second state; wherein said ferromagnetic material morphs from said normal state to said second state due to dipolar interaction when subjected to a suitable magnetic field.

This invention also provides a device for information storage, comprising said ferromagnetic material of this invention; a soft robot, comprising said ferromagnetic material of this invention; a medical patch, comprising said ferromagnetic material of this invention.

This invention further provides a method for making said ferromagnetic material of this invention. In one embodiment, said method comprises the steps of: a) Providing a mixture of unmagnetized ferromagnetic particles and precursors of said hydrogel matrix; b) Determining a crosslinking pattern to achieve said pre-determined shape based on swelling behavior and crosslinking density of said ferromagnetic material; c) Crosslinking said mixture according to said crosslinking pattern to form an unmagnetized hydrogel network with said pre-determined crosslinking density in said normal state; d) Immersing said unmagnetized hydrogel network in a solvent to convert into said second state; and e) Magnetizing said unmagnetized hydrogel network to achieve uniformly oriented ferromagnetic domains in said second state resulting in said ferromagnetic material.

### BRIEF DESCRIPTION OF THE FIGURES

FIGS. 1A and 1B illustrate the programming strategy for magnetization profile in ferromagnetic soft materials. FIG. 1A shows the preparation of a ferromagnetic soft material by the photodosage-based printing-assisted magnetization approach. A ferromagnetic hydrogel disc with heterogeneous crosslinking density is prepared, where the region with shorter photoexposure time possesses a loose hydrogel network and stronger water-absorbing capacity. The ferromagnetic hydrogel disc transforms into a cap-like 3D shape owing to its heterogeneous swelling behaviour in solvent and then undergoes a pulsed magnetic field H to form magnetized ferromagnetic domains. After removing the solvent stimulation, the hydrogel disc recovers to 2D thin film embedded with 3D magnetization profile, which enables it to replicate the cap-like 3D shape under magnetic actuation. FIG. 1B shows the inverse design strategy for programming ferromagnetic domains. The procedure begins by obtaining a scallop shell model through 3D scanning, which is discretized using a triangular mesh and flattened into a 2D meshed surface through conformal mapping. During this process, a single triangular mesh [P₁ᵢ, P₂ᵢ, P₃ᵢ] of the 3D surface is transformed into a triangular mesh [F₁ᵢ, F₂ᵢ, F₃ᵢ] of the 2D plane, and the corresponding deformation gradient between [P₁ᵢ, P₂ᵢ, P₃ᵢ] and [F₁ᵢ, F₂ᵢ, F₃ᵢ] is calculated on the basis of the coordinates of the grid points. By integrating all the meshes, the deformation gradient is converted to the exposure pattern for photodosage-based printing based on the determined relationship between swelling behaviour and crosslinking density of the ferromagnetic soft material. After photodosage-based printing-assisted magnetization, a precise 3D-distributed magnetization profile is inversely programmed throughout the ferromagnetic soft material, enabling the realization of the desired scallop shell surface under an external magnetic field B.

FIGS. 2A to 2D illustrate the photodosage-based printing-assisted preparation and magnetization of ferromagnetic soft materials. FIG. 2A is the schematics of the evolution of ferromagnetic soft materials during the photodosage-based printing-assisted magnetization process. FIG. 2B shows the effect of photoexposure time on the swelling ratio of prepared ferromagnetic hydrogel disc. FIG. 2C shows the effect of photoexposure time on the crosslinking density (Nv) and mixing enthalpy (χ) of the ferromagnetic hydrogel. The dotted line represents the fitting curve of the corresponding test results. FIG. 2D shows the effect of photoexposure time on the remanence of the ferromagnetic soft materials printed with pristine NdFeB microparticles and NdFeB@SiO₂ microparticles, respectively, demonstrating that the formation of the SiO₂ layer has minimal impact on the magnetic behaviour of ferromagnetic soft materials. The inset shows the magnetic hysteresis curves of the hydrogel structures printed with NdFeB@SiO₂ microparticles (photoexposure time 5 s). Values are means, and error bars indicate standard deviation (n=5 independent samples). Scale bar, 1 mm.

FIGS. 3A and 3B illustrate the morphological transformation of ferromagnetic soft materials printed by different exposure patterns. FIG. 3A shows the transformation mechanism of ferromagnetic soft materials fabricated with a gradient distribution of photoexposure time. U and R represent the right stretch tensor and rotation tensor, respectively. T_{mag} refers to the magnetic torque that the 3D-distributed ferromagnetic domain (M′) undergoes under magnetic field B. FIG. 3B shows a demonstration of various ferromagnetic soft materials via the modulation of exposure pattern, including gradient helical shape (i), wavy shape (ii), flower shape (iii) and wrinkling shape (iv). M_{z} represents the component of the local magnetization along the z direction. Exp., the experimental results of the swollen states of the ferromagnetic soft materials. Scale bar, 1 mm.

FIGS. 4A to 4C show the inverse design strategy for the replication of target 3D curved surfaces under magnetic actuation. FIGS. 4A and 4B show the target surface, printing design, magnetically responsive behaviour, 3D reconstruction using 3D digital microscopy, and quantitative comparison of ferromagnetic soft materials for achieving hemispheric (K>0, FIG. 4A) and conical (K=0, FIG. 4B) surfaces. FIG. 4C shows the experimental results for the inverse design of ferromagnetic soft materials to achieve intricate 3D surfaces including saddle shape (i), basin shape (ii) and curved surfaces with dual peaks (iii), triplet peaks (iv) and conch shape (v). The resulting 3D surfaces achieved through magnetic actuation demonstrate quantitative consistency with the target surfaces, thereby validating the effectiveness of the inverse design strategy. Scale bar, 1 mm.

FIGS. 5A to 5H show the demonstration of ferromagnetic soft materials for complex information storage. FIG. 5A shows the encoding and decryption of spatially discrete microsquares in a 2D film with varied photoexposure times. It showcases a gradient of colours across the microsquares, with the amplitude of M_{z} (along the dashed green line) gradually increasing as the photoexposure time decreases. FIGS. 5B to 5E show the programming of the magnetization profiles for encoding the information of Mona Lisa (FIG. 5B), QR code (FIG. 5C), fruit tree pattern (FIG. 5D) and Starry Night (FIG. 5E) paintings in ferromagnetic soft materials. The exposure patterns, optical images and magneto-optical displays are provided. The experimental results emphasize the capacity to encode and store information, encompassing not only geometric shape but also intricate colour, within ferromagnetic soft materials. FIGS. 5F to 5H show the inverse programming of ferromagnetic domains to replicate the 3D shape of a human face under magnetic actuation: the inverse design procedures of converting the target human face to the exposure pattern for photodosage-based printing (FIG. 5F); experimental results of the shape morphing of the printed ferromagnetic soft material under magnetic actuation and its 3D reconstructed surface (FIG. 5G); magnetization profile of the ferromagnetic soft material (FIG. 5H). (i, ii) The magneto-optical curves illustrate the distribution of out-of-plane magnetic flux density along the corresponding dot lines highlighting the complex positions and orientations of ferromagnetic domains embedded within ferromagnetic soft materials. Values in a are means, and error bars indicate standard deviation (n=5 independent samples). Scale bars, 1 mm (FIGS. 5A to 5E and 5H), 100 m (FIG. 5B, inset) and 5 mm (FIG. 5G).

FIGS. 6A to 6K show the demonstration of ferromagnetic soft materials for biomimetic soft robot and conformal medical patch. FIGS. 6A to 6E show the design and actuation of a stingray-inspired ferromagnetic soft robot: the morphological shape of a stingray model (FIG. 6A); the printing design for the ferromagnetic soft robot based on the target surface of the stingray (FIG. 6B); the appearance and 3D-reconstructed surface of the prepared ferromagnetic soft robot (FIG. 6C); the magnetization profile of the ferromagnetic soft robot (FIG. 6D); the swimming behaviour of the stingray-inspired ferromagnetic soft robot under magnetic actuation (FIG. 6E). FIGS. 6F to 6K show a demonstration of ferromagnetic soft material for conformal medical patch developed by inverse magnetization programming: a schematic illustration of the shape-morphing of ferromagnetic hydrogel patch for target drug delivery in the intestinal tract (FIG. 6F); the inversely designed exposure pattern for photodosage-based printing towards the target intestinal 3D surface (FIG. 6G); the magnetization profile of the prepared ferromagnetic hydrogel patch (FIG. 6H); shape morphing of the prepared ferromagnetic hydrogel patch under magnetic actuation and its 3D reconstructed surface (FIG. 6I); demonstration of the conformal ferromagnetic hydrogel patch closely wrapped on the surface of a small intestine under magnetic actuation (FIG. 6J); drug release behaviours of the hydrogel patch under different pH values (FIG. 6K). The inset images show the fluorescence images of the drug-loaded hydrogel patch at the initial state and after 2 h, respectively. The drug concentration varies significantly with changes in pH (two-sided t-test, P=0.0085, 95% confidence interval). Scale bar, 1 mm. Values are means, and error bars indicate standard deviation (n=3 independent samples).

FIGS. 7A and 7B: Comparison between different programming methods for ferromagnetic soft materials.

FIG. 8: Comparison between different design methods for ferromagnetic soft materials.

FIG. 9: Comparison between the photodosage-based printing-assisted magnetization in this work and other different magnetization programming methods for ferromagnetic soft materials.

FIG. 10: Critical parameters for the neural network model. FC stands for fully connected layers and ReLU denotes the rectified linear unit.

FIGS. 11A to 11C: Structure and property of NdFeB microparticles. FIG. 11A shows the SEM image of NdFeB microparticles. Scale bar: 10 m. FIG. 11B shows the magnetic hysteresis curve of NdFeB microparticles. FIG. 11C shows a schematic of the magnetization process of NdFeB microparticle.

FIG. 12: Decomposition of the engineered grayscale exposure pattern into N pieces of black-and-white pattern for photodosage-based printing of ferromagnetic soft materials.

FIG. 13: Discretization of ferromagnetic soft material with 3D curved surface for inverse design.

FIGS. 14A to 14C: Design of a ferromagnetic beam based on machine learning. FIG. 14A shows a schematic of the physical problem, where 8 ferromagnetic orientations are randomly assigned to 10 voxels of a ferromagnetic beam. FIG. 14B shows a flow chart of the design process. FIG. 14C shows the design results for three target shapes: time cost and optimized shapes.

FIGS. 15A to 15D: Optical (FIG. 15A) and micro-computed tomography (FIGS. 15B to 15D) images of printed hydrogel fiber. FIG. 15A shows the optical image of printed hydrogel fiber. FIG. 15B shows the 3D-reconstructed image of printed hydrogel fiber. FIGS. 15C and 15D show the cross-section of printed hydrogel fiber which demonstrates the uniform dispersion of ferromagnetic microparticles. Scale bar: 50 m in FIGS. 15A and 15B. Scale bar: 10 m in FIGS. 15C and 15D.

FIGS. 16A and 16B: Optical microscopy and micro-computed tomography images of printed ferromagnetic soft materials. FIG. 16A shows the images of ferromagnetic hydrogel containing pristine NdFeB microparticles. FIG. 16B shows the images of ferromagnetic hydrogel containing NdFeB@SiO₂ microparticles. The results indicate that both types of ferromagnetic microparticles are evenly distributed throughout the entire structure, indicating silica modification did not influence the distribution of ferromagnetic microparticles. Scale bar: 100 μm.

FIG. 17: Scanning electron microscopy and transmission electron microscopy images of the used ferromagnetic microparticles.

FIGS. 18A and 18B: Swelling kinematics of printed ferromagnetic hydrogels. FIG. 18A shows the swelling ratio changes with immersion time for the ferromagnetic hydrogel printed with different photoexposure time. FIG. 18B shows the swelling time of gels printed with different photoexposure times to reach the complete swelling. Values are means and error bars indicate standard deviation (n=3 replicates). The time needed for complete swelling ranges from ~11 s to 16 s, which is not significantly affected by the photoexposure time of the ferromagnetic hydrogel. This may be ascribed to the small size of the printed samples, where diffusion of solvent occurs rapidly.

FIG. 19: Measured modulus and solvent content of ferromagnetic soft materials prepared with different photoexposure times in swollen and shrunken states. The modulus of the hydrogel exhibits an initial increase in both fully swollen and shrunken states, followed by a plateau, which indicates complete polymerization of the hydrogel. The solvent content in the swollen state is higher than in the shrunken state, suggesting a decrease in volumetric crosslinking density during swelling. Furthermore, as the photoexposure time increases, the solvent content of the hydrogel gradually decreases, indicating a corresponding increase in the hydrogel's crosslinking density. Values are means and error bars indicate standard deviation (n=3 replicates). The solvent content ranges from ~78 to 87 wt. % in the swollen state. It can be found that the solvent content of ferromagnetic hydrogel in the swollen state is higher than that in the shrunken state, suggesting a decrease in the volumetric crosslinking density when swollen, which matches well with the measured changes in the hydrogel stiffness.

FIGS. 20A to 20D: Resolution definition (negative resolution) for ferromagnetic soft materials. FIG. 20A shows the printing design of a circular pattern (diameter: 200 m). FIG. 20B shows the swollen state of ferromagnetic soft material. FIG. 20C shows the magneto-optical image of ferromagnetic soft material. FIG. 20D shows the magnetization profile along the green dashed line which is horizontally scanned across the circular pattern as shown in FIG. 20A. The experimental results in FIG. 20B exhibit the local bulge shape of the ferromagnetic soft material in the swollen state. Scale bar: 200 μm.

FIGS. 21A to 21C: Magneto-optical results of a 2D film with encoded microcircle pattern. FIG. 21A shows the results of microcircle pattern with the diameter of 400 μm, 600 μm, and 800 μm. FIG. 21B shows the results of microcircle pattern with the diameter of 50 μm, 100 μm, and 200 μm. FIG. 21C shows the results of microcircle pattern with the diameter of 10 μm, 20 μm, and 30 μm. The curve on the rightmost illustrates the distribution of magnetization along the green dashed line in the printing design. Values are means and error bars indicate standard deviation (n=5 replicates). Scale bar: 500 μm.

FIG. 22: Horizontal scanning result of the magnetization profile of 50 μm-diameter circular pattern. Values are means and error bars indicate standard deviation (n=5 replicates).

FIGS. 23A to 23D: Resolution definition (positive resolution) for ferromagnetic soft materials. FIG. 23A shows the printing design of a circular pattern (diameter: 200 m). FIG. 23B shows the swollen state of ferromagnetic soft material. FIG. 23C shows the magneto-optical image of ferromagnetic soft material. FIG. 23D shows the magnetization profile along the green dashed line that is horizontally scanned across the circular pattern as shown in FIG. 23A. The experimental results in FIG. 23B exhibit the local bulge shape of the ferromagnetic soft material in the swollen state. Scale bar: 200 μm.

FIG. 24: An overview comparing magnetization resolution and magnetization state of this work with different magnetization programming strategies. 2D magnetization refers to the orientation of magnetization in each layer being restricted to a single plane. 3D magnetization refers to the ability to program the orientation of magnetization in any arbitrary direction. Discrete magnetization refers to the situation where each area's magnetization is independent of adjacent areas, while continuous magnetization indicates that the magnetization direction of adjacent areas changes continuously. Based on the programming mechanism of ferromagnetic domains, the programming strategies are divided into two categories. The first is the voxel-by-voxel programming technique, which includes electron beam litography-assisted magnetization⁵⁶, direct ink writing (DIW) printing-assisted method^{47,63}, two-photon polymerization (TPP) printing-assisted method^{61,64}, microassembly method^{58,65}, laser-assisted reprogramming method⁵⁷, adhesive tape-assisted magnetization⁶², digital light processing (DLP) printing-assisted method^{48,66}. The second is one-step programming technique, primarily achieved with the assistance of templates^{67,54,68}. 3D magnetization is generally considered to be superior to 2D magnetization, as the former can enhance the design freedom to achieve more complex shape transformations. But 3D continuous magnetization and 3D discrete magnetization both have their own advantages and disadvantages. The continuous magnetization method may affect the deformation amplitude of magnetic actuation due to the gradual change in ferromagnetic orientation between adjacent regions; however, it offers good manufacturability and high forming efficiency because it can complete magnetization in one step. In contrast, the discrete magnetization method can produce enhanced deformation amplitudes due to the rapid changes in spatial magnetization orientation. However, the interaction between ferromagnetic particles during the fabrication process can lead to structural inhomogeneity, such as particle agglomeration. Additionally, since voxels must be adjusted individually, specific processing equipment is required and the fabrication time is prolonged.

FIGS. 25A to 25C: Schematic illustration (FIG. 25A) of the deformation of a uniform helical structure, the results of its rotation matrix distribution (FIG. 25B), and the formation of 3D-distributed ferromagnetic domain (FIG. 25C). It shows the structural rotation produced by each voxel when the flat strip-shaped structure transforms into a helical structure, which can be used to analyze the formation of anisotropic ferromagnetic domains. FIG. 25C illustrates the analysis results of anisotropic ferromagnetic domain distribution formed by recovery from a uniform helical structure to its flat strip-shaped shape, which can be verified by the experimental results shown in FIGS. 28A to 28C. M₀ represents the maximum value of the remanence in the ferromagnetic soft material.

FIGS. 26A and 26B: Analysis results of the rotation matrix distribution and the formation of 3D-distributed ferromagnetic domain for ferromagnetic soft materials transforming into a gradient helical shape. FIG. 26A shows the rotation matrix distribution of ferromagnetic soft materials transforming from a flat strip-shaped structure to a gradient helical structure. FIG. 26B shows the anisotropic ferromagnetic domain distribution formed by recovery from a gradient helical structure to its flat strip-shaped shape. M₀ represents the maximum value of the remanence in the ferromagnetic soft material.

FIG. 27: Flow chart and experimental results for programmable magnetic responsive behaviors (bending and bulging) via the arrangement of exposure pattern. The deformation outcomes of the ferromagnetic soft materials demonstrate the consistent morphological transformation achieved through magnetic actuation and heterogeneous swelling.

FIGS. 28A to 28C: Demonstrations for morphological transformation of helical structure (FIG. 28A), flower shape structures with bending petals (FIG. 28B) and twisting petals (FIG. 28C). By designing the exposure pattern for ferromagnetic soft materials, various deformed shapes including helical and flower-shaped deformations can be presented. Scale bar: 1 mm.

FIGS. 29A to 29G: Simulation results of the magnetic-responsive behavior with various exposure patterns to achieve helical shapes (FIGS. 29A and 29B), wavy shape (FIG. 29C), flower shapes (FIGS. 29D to 29F), and wrinkling shape (FIG. 29G). The agreement between the experimental and simulation results validates the effectiveness of the proposed FEA model, and also shows that the FEA model could guide the design of exposure pattern required to achieve preliminary deformation of ferromagnetic soft materials.

FIG. 30: Experimental results for the inverse design of ferromagnetic soft materials to achieve intricate 3D surfaces including hemispheric shape (i), conical shape (ii), saddle shape (iii), basin shape (iv), curved surfaces with dual peaks (v), triplet peaks (vi), and conch shape (vii). The solvent-responsive behaviors and 3D-reconstructed surfaces validate the proposed inverse design strategy. The resulting magnetization profiles manifest a rich abundance of orientation information, enabling the ferromagnetic soft materials to achieve target surface under complex magnetic dipolar interaction. Scale bar: 1 mm.

FIGS. 31A to 31G: Micro-computed tomography images of ferromagnetic soft materials without and with magnetic actuation. Sphere (FIG. 31A), cone (FIG. 31B), saddle (FIG. 31C), basin shapes (FIG. 31D), conch (FIG. 31E), dual peaks (FIG. 31F), and triplet peaks (FIG. 31G). Compared with the target surface, the resulting data of the 3D surfaces validate the effectiveness of our inverse design strategy.

FIGS. 32A to 32E: Simulation study for the ferromagnetic soft material with microsquare pattern. FIG. 32A shows the deformation of the ferromagnetic soft material via heterogeneous swelling in solvent. FIG. 32B shows the magnetic flux density distribution (M_{z}) induced by the ferromagnetic soft material and measured by magnetooptical sensor. FIGS. 32C to 32E show the magnetization profile (Mᵤ, Mᵥ, M_{w}) programmed in the 2D film. The simulation results illustrate the principle of the encryption and storage of a single cubic voxel and show agreement with the experimental results in FIG. 5A and FIG. 33.

FIG. 33: Illustration of the information storage and decryption process for cubic voxels. Scale bar: 1 mm. The experimental results exhibit the local bulge shape of the ferromagnetic soft material when immersed in deionized water, and the magneto-optical result demonstrates the effectiveness of the encoding of spatially discrete microsquares into the 2D film.

FIGS. 34A and 34B: Magnetization programming of ferromagnetic soft materials with designed patterns including four-petal shapes (FIG. 34A), “CUHK” letters (FIG. 34B). Scale bar: 1 mm. The experimental results demonstrate the capability of information storage of our proposed method, as micropatterns with various geometric shapes can be programmed into ferromagnetic soft materials.

FIG. 35: Schematic illustration of the relationship between magnetization intensity (M_{z}) and photoexposure time. The 3D surface of the scallop shell model is discretized using triangular meshes. Each mesh ([F₁ᵢ, F₂ᵢ, F₃ᵢ]) is assigned with a corresponding photoexposure time parameter t. Deformed meshes ([P₁ᵢ, P₂ᵢ, P₃ᵢ]) are formed due to heterogeneous swelling of the ferromagnetic soft material, and the corresponding deformation gradient between [P₁ᵢ, P₂ᵢ, P₃ᵢ] and [F₁ᵢ, F₂ᵢ, F₃ᵢ] is calculated based on the coordinates of the grid points. After magnetization and recovery to its flat surface, a 3D-distributed magnetization profile (M) is programmed throughout the ferromagnetic soft material. In this context, the magnetization parameter M of triangular mesh [F₁ᵢ, F₂ᵢ, F₃ᵢ] depends on its deformation gradient F. Therefore, the modulation of photoexposure time parameter t can be used to adjust magnetization parameter M. The relationship between magnetization and photoexposure time in ferromagnetic soft materials can guide the design of photodosage-based printing.

FIG. 36: Relationship between magnetization intensity (M_{z}) and photoexposure time. The fitting curve shows that:

$${M}_{z} = - 2.345 + \frac{5.212}{1 + ( {t}^{3.647} / 809 \; 0.116 )} ,$$

where R²=0.99. The right inset displays the printing design of the ferromagnetic soft material, where the photoexposure time for the encoded square pattern is t, and the photoexposure time for the other area is 25 s. Values are means and error bars indicate standard deviation (n=5 replicates). The left insets show partially zoomed-in side views of the simulation results for the swollen state of ferromagnetic soft materials with photoexposure times of 9 s and 15 s, respectively. The modeling result is derived from the analysis of the deformation gradient of the ferromagnetic soft materials in their swollen state (Supplementary Notes 3 and 7). The M_{z} value of the microsquare is measured via the magneto-optical sensor. When the microsquare pattern is designed with a lower photoexposure time compared to the surrounding rectangular area, the square area features a lower crosslinking density and a larger swelling ratio, resulting in the formation of a localized raised area when immersed in a solvent. After magnetization and recovery to the initial flat state, the magnetization profile of the microsquare area will differ significantly from that of the surrounding rectangular area. With the increase of photoexposure time in the microsquare pattern, the amplitude of local deformation gradually decreases, leading to the decrease of M_{z}. Therefore, the magnetization profile (M_{z}) can be adjusted by varying the photoexposure time, which enables us to encode information in the ferromagnetic soft material.

FIGS. 37A to 37F: Design and actuation of cuttlefish-inspired ferromagnetic soft robot. FIG. 37A shows the design of the exposure pattern. FIGS. 37B and 37C show the swollen state and shrunken state of the soft robot. FIG. 37D shows the magnetic flux density distribution of the soft robot. FIGS. 37E and 37F show the deformation and locomotion of the cuttlefish-inspired robot under magnetic stimulation. Scale bar: 1 mm. The experimental results exemplify the potential of the proposed method in constructing soft robots capable of emulating the intricate 3D morphology observed in various living creatures.

FIG. 38: A flow diagram illustrating the optimization of magnetic actuation effects based on feedback from experimental results.

FIG. 39A to 39G: The feasibility of the proposed error compensation method is demonstrated using a semicircle as the target surface. FIG. 39A shows the target surface of the ferromagnetic soft material along with the coordinate distribution of its central axis. FIG. 39B shows the orientation distribution of magnetic domains along the central axis of the ferromagnetic soft material when the target surface is used as the initial swollen shape for magnetization. M₀ represents the remanence, and Mₓ and M_{z} are the components of the local remanence in the x-direction and z-direction, respectively. FIG. 39C shows the magnetic actuation results obtained through FEA analysis and their comparison with the target shape. FIG. 39D shows the distribution of the error (eᵢ) in the magnetic actuation results. Along the central axis, the ferromagnetic soft material is discretized into N=16 sub-regions, where L₀ is the length of structure, and s is the arc length of the current node from one endpoint of the structure. FIG. 39E shows a comparison between the revised swollen state obtained after error compensation and the initial swollen state, with the correction coefficient k set to 1. FIG. 39F shows the distribution of the error (eᵢ) in the magnetic actuation results of the ferromagnetic soft material after magnetization under the revised swollen state. The inset shows a comparison of the cumulative error (e) before and after the revision, indicating a significant reduction in error. FIG. 39G shows the revised magnetic actuation result obtained through FEA analysis and its comparison with the target shape, showing improved shape consistency.

### DETAILED DESCRIPTION OF THE INVENTION

This invention provides a ferromagnetic material. In one embodiment, said ferromagnetic material comprises: a) A hydrogel network comprising a pre-determined crosslinking density such that said hydrogel network can morph between a normal state and a second state, wherein said second state comprises a pre-determined shape resulting from said pre-determined crosslinking density; and b) Ferromagnetic particles entangled in said hydrogel network, wherein said ferromagnetic particles form uniformly oriented ferromagnetic domains in said second state; wherein said ferromagnetic material morphs from said normal state to said second state due to dipolar interaction when subjected to a suitable magnetic field.

In one embodiment, said pre-determined crosslinking density is formed by photodosage-based printing.

In one embodiment, said hydrogel network comprises polymer chains with amino groups and/or carboxylic groups.

In one embodiment, said hydrogel network is formed from one or more monomers selected from the group consisting of chitosan, acrylic acid, methacrylic acid, and N-isopropylacrylamide.

In one embodiment, said second state is achieved by immersing said hydrogel network in a solvent. Depending on the environmental response characteristics of said ferromagnetic material, on top of the solvent used in the examples, said solvent can also be any suitable acidic or alkaline solution.

In one embodiment, said ferromagnetic particles are one or more selected from the group consisting of chromium oxide (CrO₂), barium ferrite, and NdFeB@SiO2.

In one embodiment, said second state comprises a 3D surface.

In one embodiment, said ferromagnetic material comprises a portion with microlattice design.

In one embodiment, said normal state is a 2D film.

This invention also provides a device for information storage, comprising said ferromagnetic material of this invention; a soft robot, comprising said ferromagnetic material of this invention; a medical patch, comprising said ferromagnetic material of this invention. In one embodiment, movement of said soft robot is induced by exposing to an external magnetic field to cause said ferromagnetic material to morph between said normal state and said second state. In one embodiment of the medical patch, said pre-determined shape is a shape adopted for covering a biological surface. In another embodiment of the medical patch, said hydrogel matrix is loaded with a drug to be released.

This invention further provides a method for making said ferromagnetic material of this invention. In one embodiment, said method comprises the steps of: a) Providing a mixture of unmagnetized ferromagnetic particles and precursors of said hydrogel matrix; b) Determining a crosslinking pattern to achieve said pre-determined shape based on swelling behavior and crosslinking density of said ferromagnetic material; c) Crosslinking said mixture according to said crosslinking pattern to form an unmagnetized hydrogel network with said pre-determined crosslinking density in said normal state; d) Immersing said unmagnetized hydrogel network in a solvent to convert into said second state; and e) Magnetizing said unmagnetized hydrogel network to achieve uniformly oriented ferromagnetic domains in said second state resulting in said ferromagnetic material.

In one embodiment, said crosslinking pattern is an exposure pattern for photodosage-based printing.

In one embodiment, said step (b) comprises the steps of: i) Obtaining 3D information of said pre-determined shape; ii) Discretizing said 3D information using a 3D mesh; iii) Flattening said 3D mesh into a 2D mesh through conformal mapping and obtaining a deformation gradient between said 3D mesh and 2D mesh; and iv) Determining said crosslinking pattern from said deformation gradient based on a determined relationship between swelling behavior and crosslinking density of the ferromagnetic material.

In one embodiment, said step (e) comprises exposing said unmagnetized hydrogel network to a pulsed magnetic field.

In one embodiment, said 3D mesh and said 2D mesh are triangular meshes.

### Programming Strategy for Ferromagnetic Soft Materials

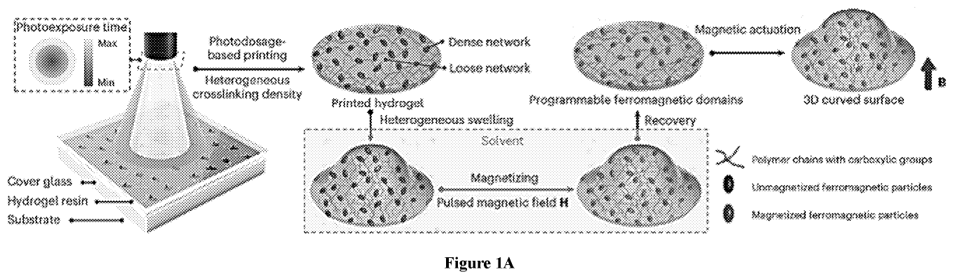

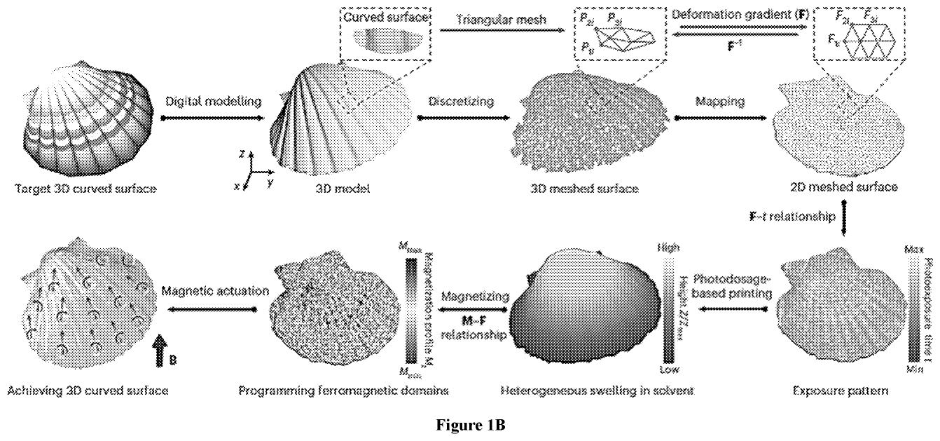

A photodosage-based printing-assisted template-free magnetization approach is proposed for the programming of ferromagnetic soft materials (FIG. 1A and Supplementary Note 1). The hydrogel resin is mainly composed of solvent-responsive monomers (acrylic acid (AAc) and methacrylic acid (MAAc)), unmagnetized neodymium iron boron (NdFeB) microparticles, a crosslinker and a photoinitiator. The magnetic microparticles exhibit irregular shapes and hard-magnetic properties (FIGS. 11A to 11C). Through exposing hydrogel resin with an engineered ultraviolet (UV) light pattern (for example, a circular pattern consisting of spatially varying photoexposure time; Supplementary Note 2 and FIG. 12), a thin ferromagnetic hydrogel disc with heterogeneous crosslinking density is obtained. The region with shorter photoexposure time possesses lower crosslinking density and stronger water-absorbing capacity, and vice versa. Therefore, when immersed in water, the hydrogel disc exhibits spatially non-uniform swelling behaviour, leading to the out-of-plane buckling into a cap-like 3D shape. Subsequently, a pulsed magnetic field H (~2.5 T) is applied to magnetize the embedded ferromagnetic domains and then transfer the hydrogel to phosphate buffer solution (PBS). The carboxylic groups of hydrogel network originating from AAc and MAAc monomers are ionized from —COOH to —COO⁻, which exert electrostatic repulsive force to each other. Such interaction is strong enough to induce the monolithic swelling of hydrogel regardless of crosslinking density, thus recovering the cap-like 3D shape to 2D thin film. During this process, the ferromagnetic domains embedded in hydrogel matrix are programmed with a 3D-distributed magnetization profile, which can drive the deformation of soft film to replicate the cap-like 3D shape when an actuating magnetic field B (≤100 mT) is applied.

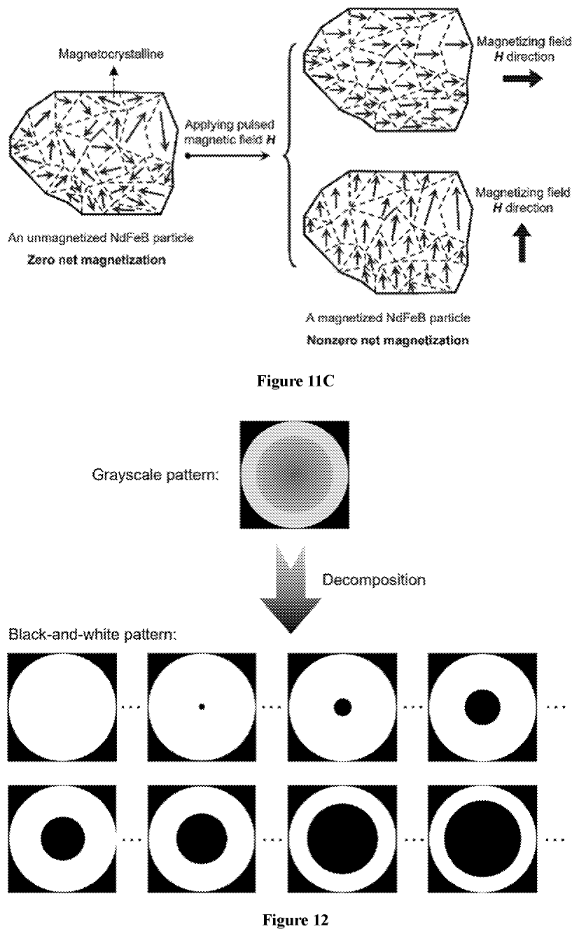

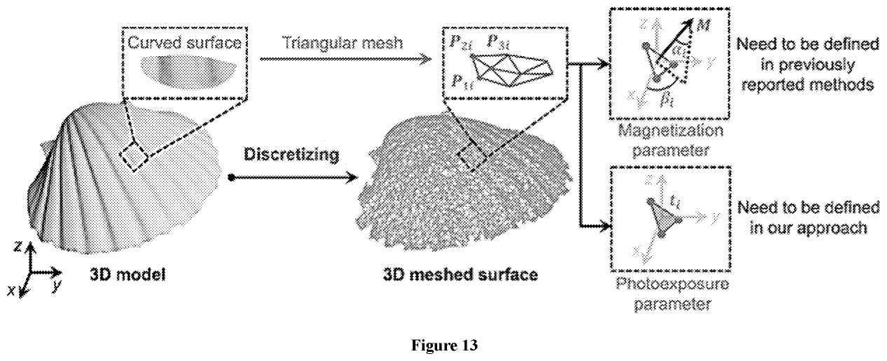

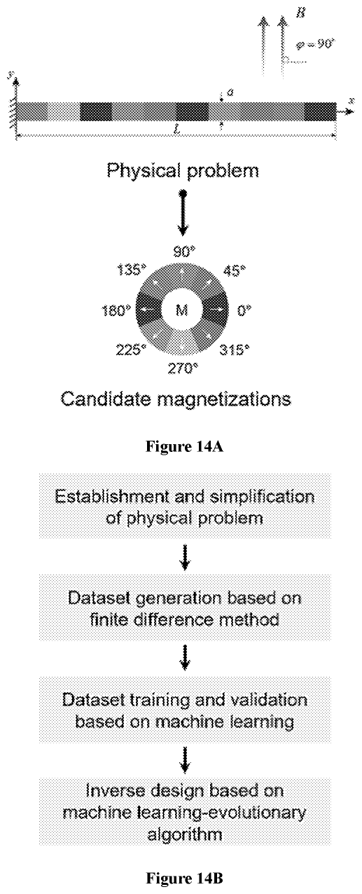

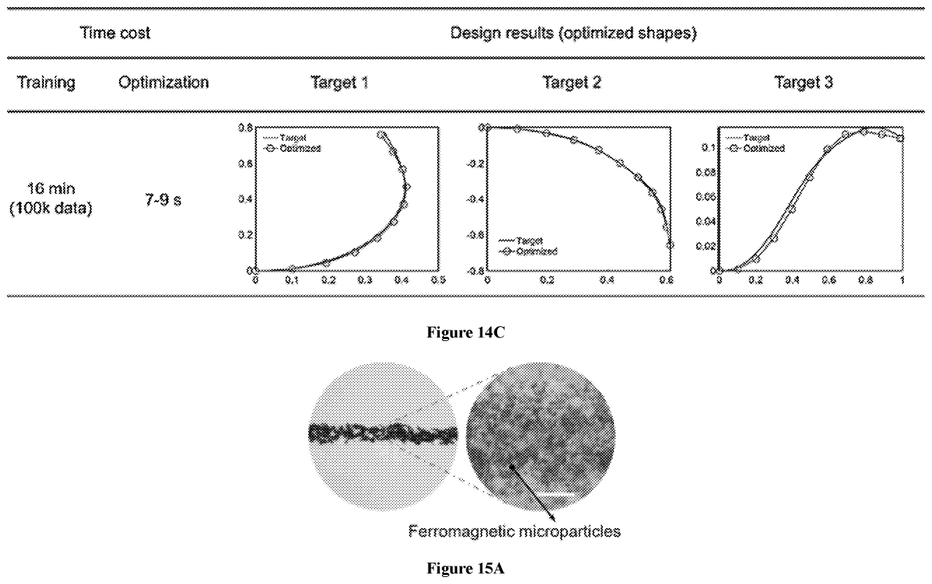

The key concepts and procedures of the inverse design strategy for programming ferromagnetic domains are illustrated using a scallop shell obtained through 3D scanning as an example of the target 3D curved surface (FIG. 1B and Supplementary Note 3). The scallop shell model is discretized using a triangular mesh and subsequently flattened into a 2D meshed surface. Using the developed ferromagnetic hydrogel with a determined relationship between swelling behaviour and crosslinking density, the deformation gradient of each local region deduces the required photoexposure time. By integrating all the meshes of the scallop shell surface, a complete UV light pattern containing the photoexposure time distribution information is obtained. Finally, photodosage-based printing is used to expose the ferromagnetic hydrogel, followed by heterogeneous swelling, magnetization and recovery, leading to the programming of a specific 3D-distributed magnetization profile throughout ferromagnetic soft material. When an actuating magnetic field B is applied, the inversely programmed ferromagnetic domains trigger the morphing of ferromagnetic soft material to replicate the target scallop shell surface via magnetic dipole interactions. In this manner, computing the configurations of each ferromagnetic domain should be avoided for the target 3D shape, which is an extremely high-degree-of-freedom and hard-to-solve problem, and instead only need to modulate the crosslinking density of ferromagnetic soft material using photodosage-based printing, making the inverse design much more straightforward and solvable. Compared with existing methods for designing ferromagnetic soft materials, the approach of this invention achieves processing of a smaller parameter space and possesses no dependence on the acquisition of a large dataset, which allows the construction of ferromagnetic soft materials with complex magnetization profiles necessary for various 3D curved surfaces (Supplementary Note 4, Supplementary Table 2, and FIGS. 13, 14A to 14C).

### Photodosage-Based Printing-Assisted Magnetization

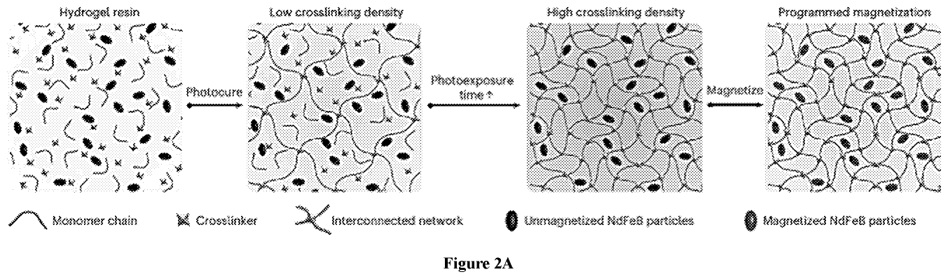

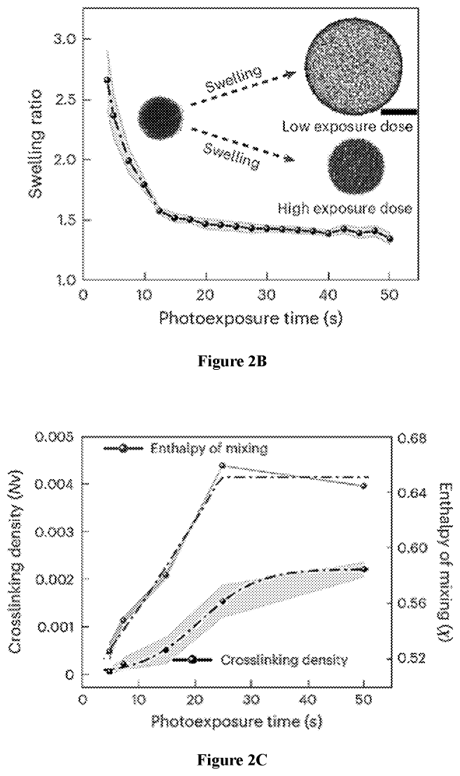

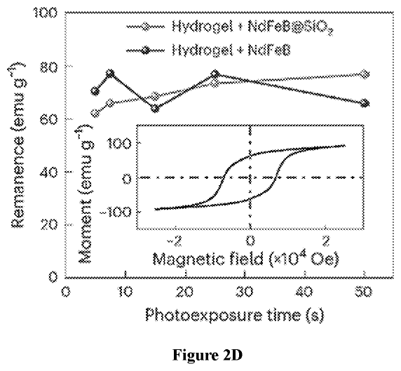

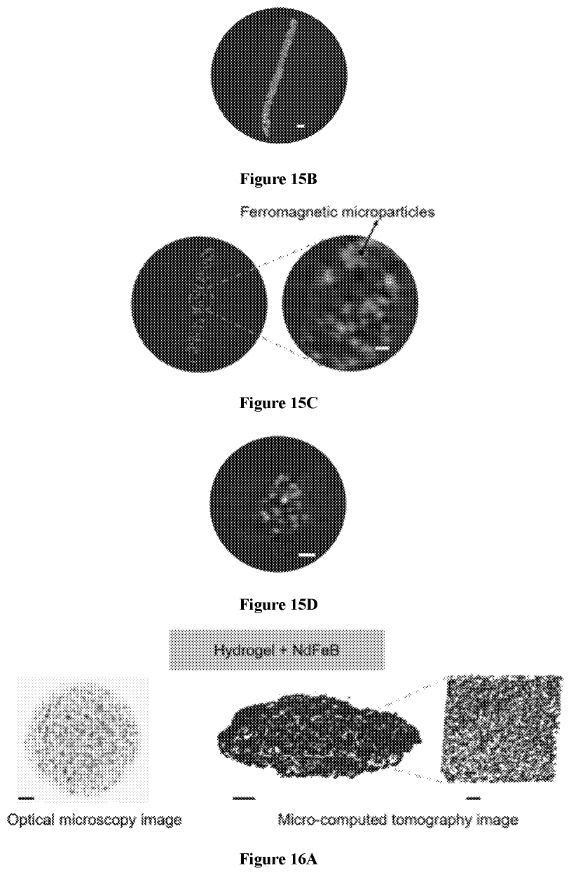

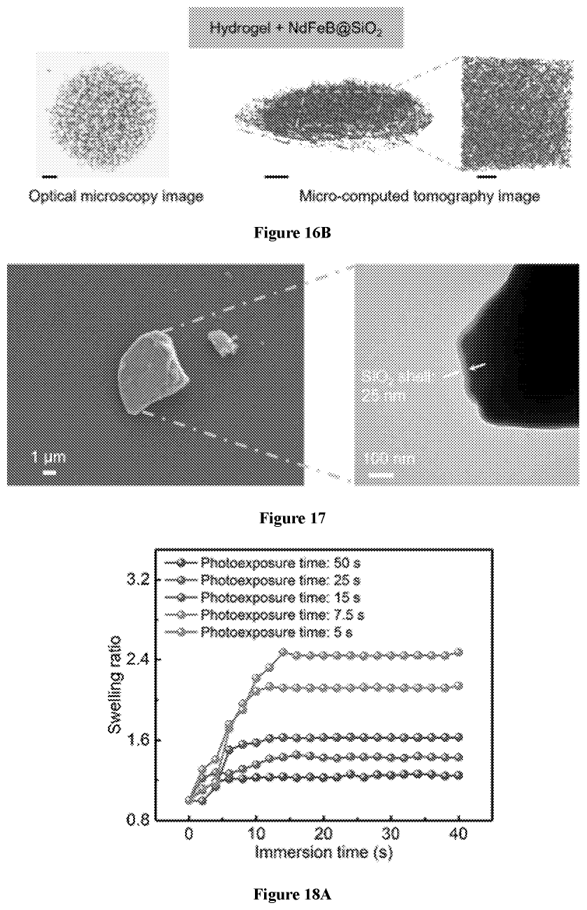

The microscopic evolution of ferromagnetic soft materials during the photodosage-based printing-assisted magnetization process shows the formation of a denser hydrogel network with increasing photoexposure doses, along with the magnetized hydrogel network (FIG. 2A). Upon UV light exposure, the monomer chains and crosslinker in hydrogel resin interconnect to form the network of soft material, within which ferromagnetic particles are uniformly embedded (FIGS. 15A to 15D and 16A to 16D). A thin silica layer with a thickness of ~25 nm was formed on the surface of a NdFeB microparticle, primarily aiming to prevent the oxidation and corrosion of the NdFeB microparticle in humid environment (FIG. 17). The obtained ferromagnetic soft material exhibits excellent water affinity and swells once immersed in deionized water. Through elevating the UV light photoexposure time, the polymeric network becomes denser, which limits the water-absorbing capability and swelling behaviour of ferromagnetic soft material (FIGS. 18A and 18B). For example, a set of identically sized ferromagnetic hydrogel discs (1.7 mm in diameter and 500 μm in thickness) is printed using a fixed exposure power of 50 mW cm⁻² and a gradually varied photoexposure time from 4 to 50 s. After they are fully swollen in deionized water, the change of disc diameter (that is, the swelling ratio) as a function of photoexposure time is plotted in FIG. 2B, which increases steadily and gradually reaches a plateau as the photoexposure time approaches ~25 s. The crosslinking density of ferromagnetic hydrogel is characterized based on the Flory theory following the previous work¹⁶ (Supplementary Note 5), which only requires measuring the elastic moduli of discs printed with various photoexposure time at the fully swollen state (FIG. 19). A dimensionless parameter Nv (N and v denote the number of effective polymeric chains and the volume per molecule, respectively) is subsequently derived in FIG. 2C to quantitatively represent the crosslinking density of hydrogel network. In addition, FIG. 2C shows the variation of Flory interaction parameter χ of ferromagnetic hydrogel that denotes the enthalpy of mixing between the solvent and polymer with the increase of photoexposure time. Both parameters Nv and χ increase dramatically and then level off when the photoexposure time is longer than ~25 s, indicating that the hydrogel is fully polymerized, and the mixing interaction between water and polymeric network approaches saturation. These trends are consistent with that of the swelling ratio, implying that the modulation of photoexposure time in photodosage-based printing can finely adjust the crosslinking density and swelling behaviour of ferromagnetic hydrogel.

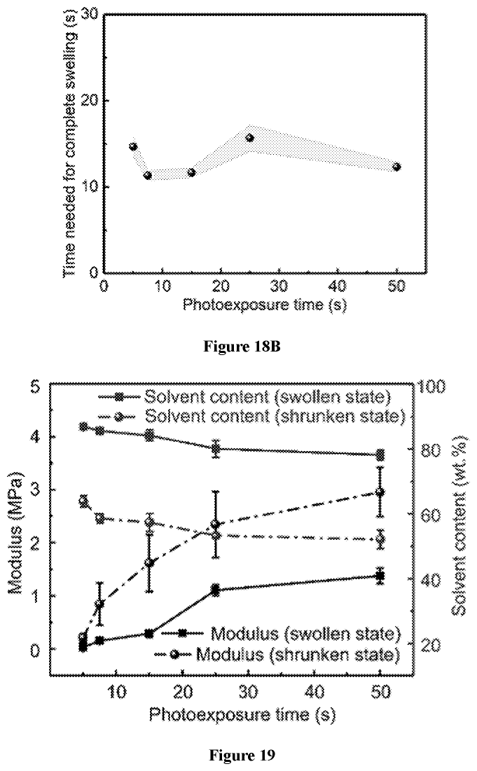

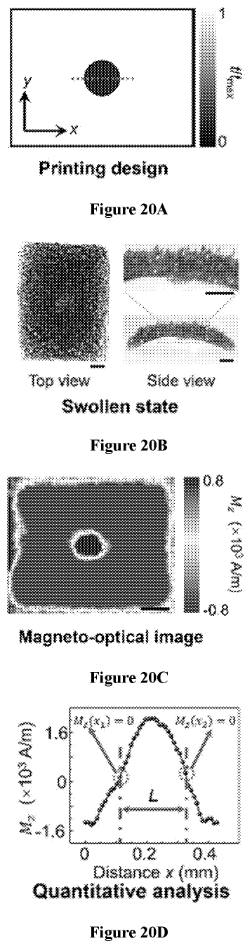

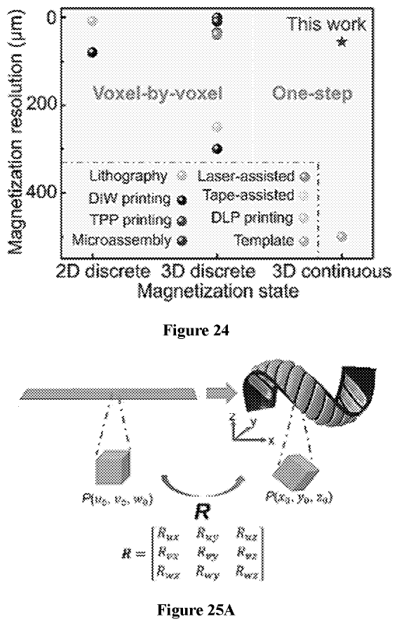

After the magnetization process, the hard-magnetic domains inside the hydrogel matrix are programmed with oriented remanent magnetism, dependent on the hydrogel swollen state and pulsed magnetic field H. The change of photoexposure time and the modification of the silica layer exhibit limited impact on the magnetic properties of ferromagnetic hydrogel (FIG. 2D). The developed photodosage-based printing-assisted magnetization strategy demonstrates a programming resolution as high as ~50 m and can be further optimized by using smaller ferromagnetic particles (Supplementary Note 6 and FIGS. 20A to 20D, 21A to 21C, 22, and 23A to 23D). A comprehensive overview of magnetization programming methods for ferromagnetic soft materials regarding magnetization resolution and magnetization state demonstrates that the method of this invention outperforms most current studies with its superiority in configuring finer ferromagnetic domains with higher efficiency (FIG. 24 and Supplementary Table 3). In this invention, the printing of ferromagnetic soft materials typically takes ~2 min, and the parallel manufacturing of multiple structures is possible, depending on the irradiation area of the UV light source. Besides, the subsequent heterogeneous swelling in solvent, magnetization using a pulsed magnetic field, and recovery procedures can be accomplished within 5 min, making the approach of this invention suitable for the mass production of ferromagnetic soft materials.

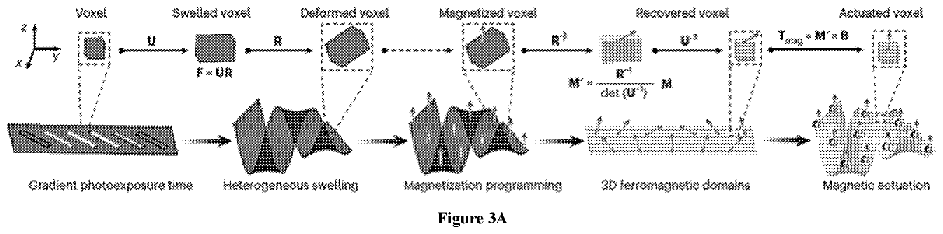

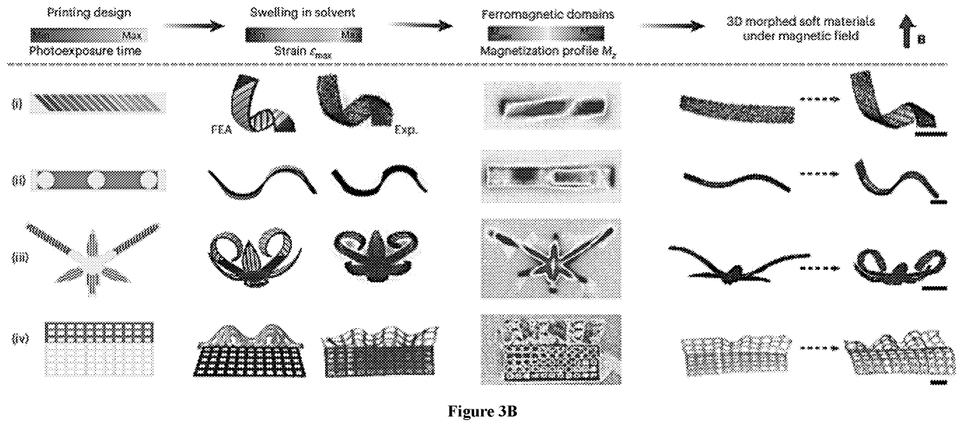

The transformation mechanism of the ferromagnetic soft materials is illustrated using a strip-shaped exposure pattern featuring a gradient distribution of photoexposure time (FIG. 3A). The ferromagnetic soft strip is fabricated through the proposed photodosage-based printing method, and the swelling ratio of each voxel can be computed according to the photoexposure time. When subjected to solvent stimulation, each voxel within ferromagnetic soft material experiences volume expansion (U, right stretch tensor). The heterogeneous swelling ratio induces internal stress within the strip, leading to the rigid body rotation (R, rotation tensor) of the voxel. The superimposition of volume expansion and voxel rotation results in the large deformation of the voxel:

$$F = RU , \qquad Formula ( 1 )$$

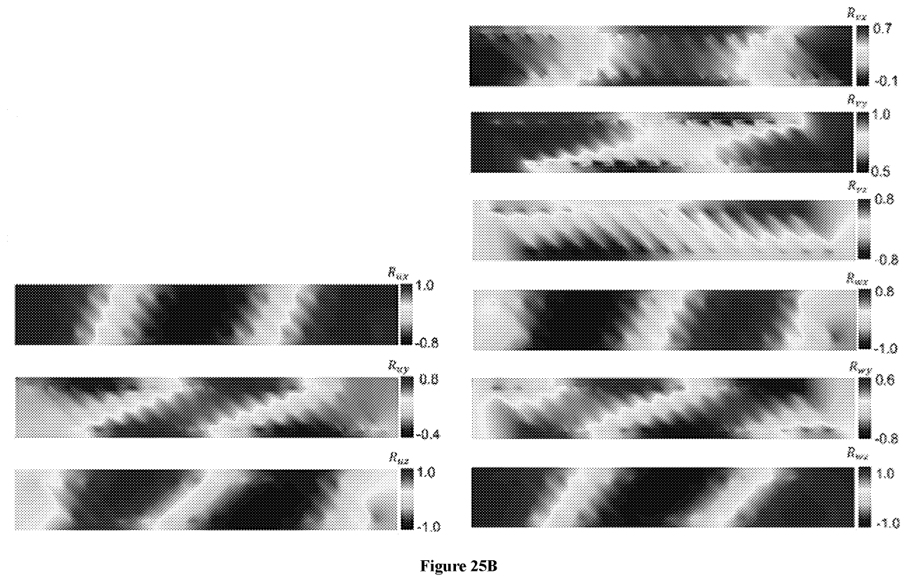

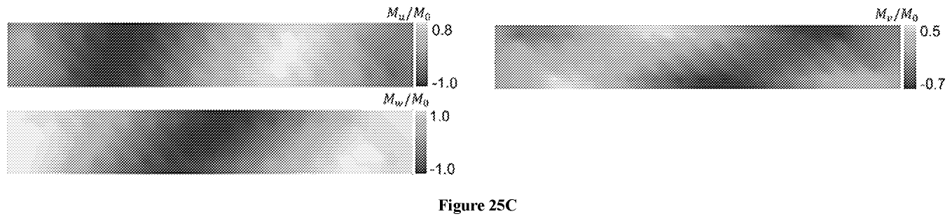

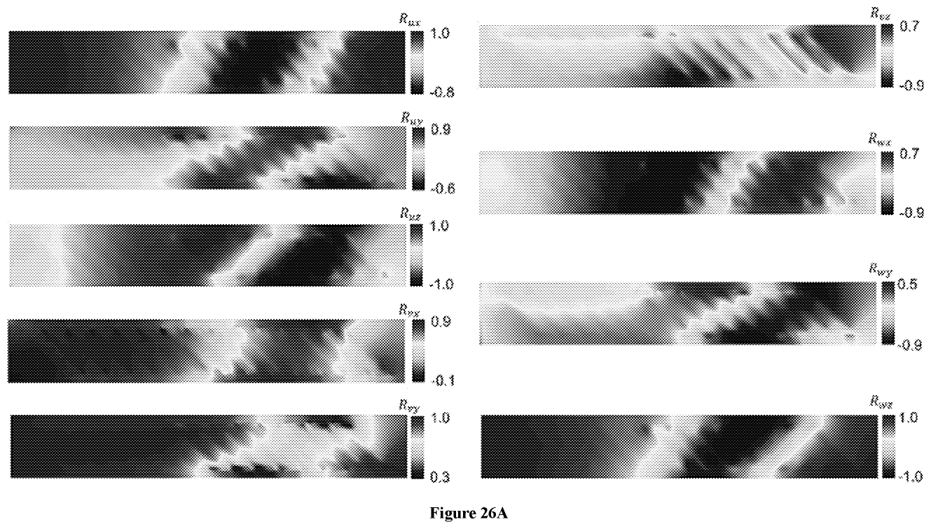

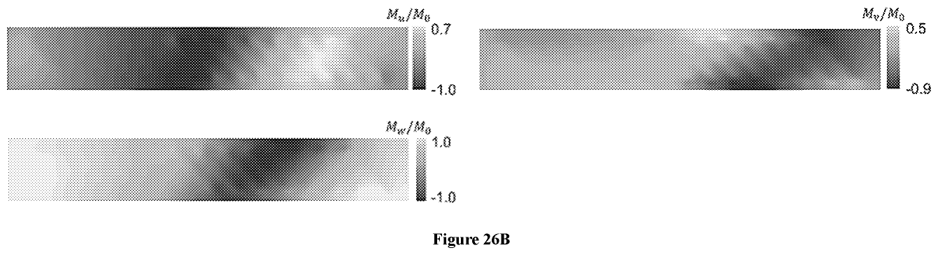

deformation gradient (Supplementary Note 7 and FIGS. 25A to 25C, 26A and 26B). Incorporating the boundary conditions and mechanical properties of the ferromagnetic soft material, the deformation of the strip can be determined through finite element analysis (FEA), resulting in the gradient helix shape shown in FIG. 3A. Subsequently, the ferromagnetic soft material is magnetized in the deformed state, resulting in uniformly oriented ferromagnetic domains (M). Upon transferring the magnetized strips to PBS, each voxel undergoes volume shrinkage (U⁻¹) and rotations (R⁻¹), thereby recovering the structure to its original shape:

$${F}^{- 1} = {R}^{- 1} {U}^{- 1} \qquad Formula ( 2 )$$

Notably, this process transforms the initially uniformly oriented ferromagnetic domains into 3D-distributed ferromagnetic domains (M′) in the strip, which can be derived by:

$${M}^{′} = \frac{{R}^{- 1}}{det ( {U}^{- 1} )} M \qquad Formula ( 3 )$$

Through the magnetic dipolar interaction between 3D-distributed ferromagnetic domains and the actuating magnetic field:

$$T = {M}^{′} \times B , \qquad Formula ( 4 )$$

the strip can transform into the gradient helical surface.

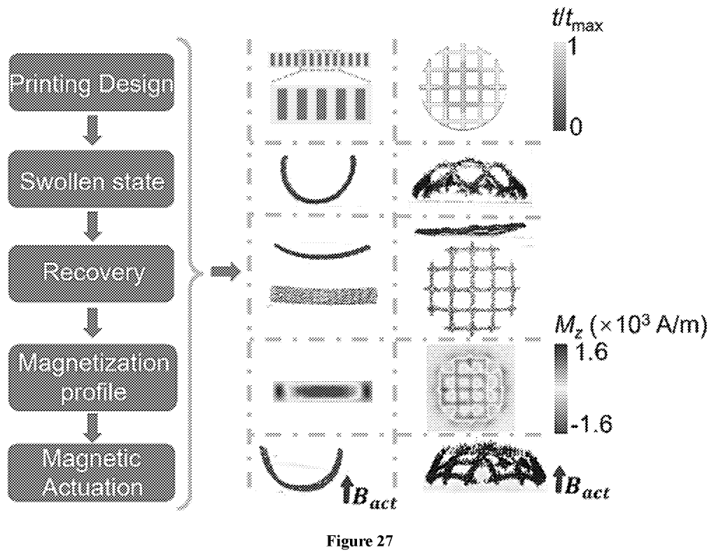

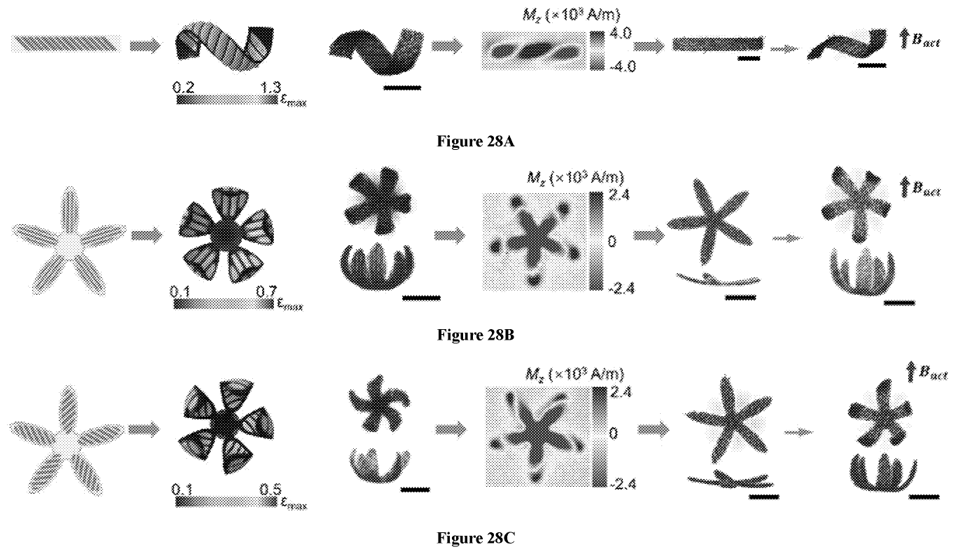

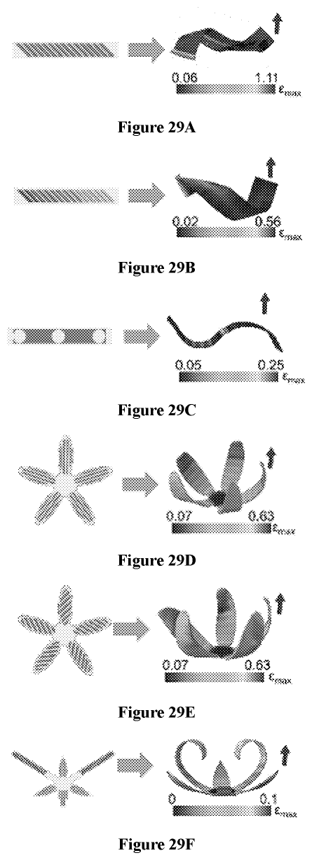

By designing the exposure pattern of photodosage-based printing, various 3D deformations can be achieved using ferromagnetic hydrogel (FIG. 3B, FIGS. 27, 28A to 28C, and 29A to 29G). Multiple fundamental deformation modes, such as bending, twisting, waving and wrinkling, are showcased. Furthermore, with the assistance of the FEA method, the ferromagnetic hydrogel can deform into more intricate shapes (for example, the 3D curved surface of a native orchid that combines fundamental deformation modes in a single structure). The deformation outcomes of the ferromagnetic hydrogels demonstrate the accurate predictive capabilities of the FEA method and the consistent morphological transformations achieved through magnetic actuation and heterogeneous swelling. Despite the preliminary deformation observed in ferromagnetic soft materials (FIG. 3B), their magnetization profiles already exhibit a rich abundance of orientation information.

### Inverse Design Strategy for the Target 3D Curved Surfaces

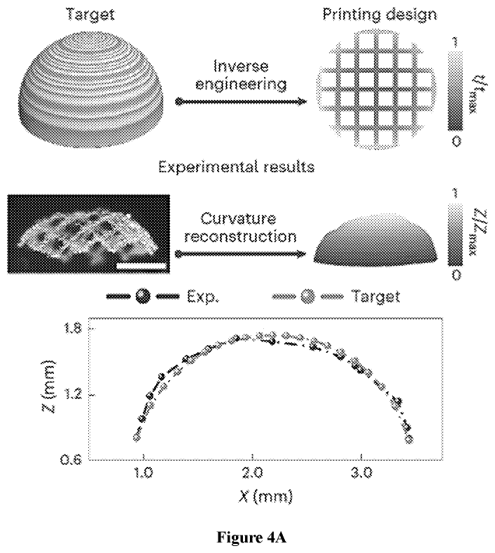

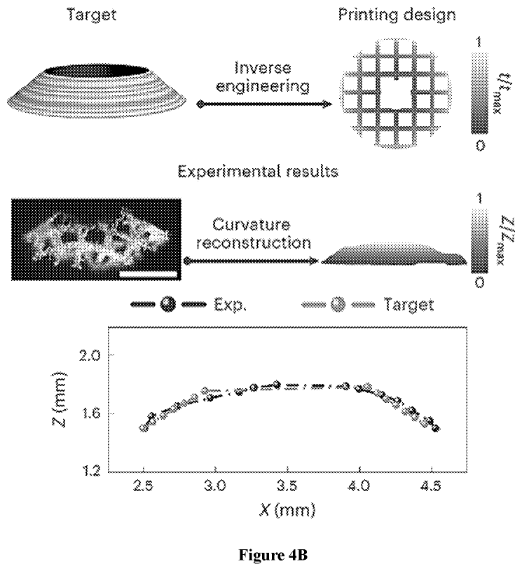

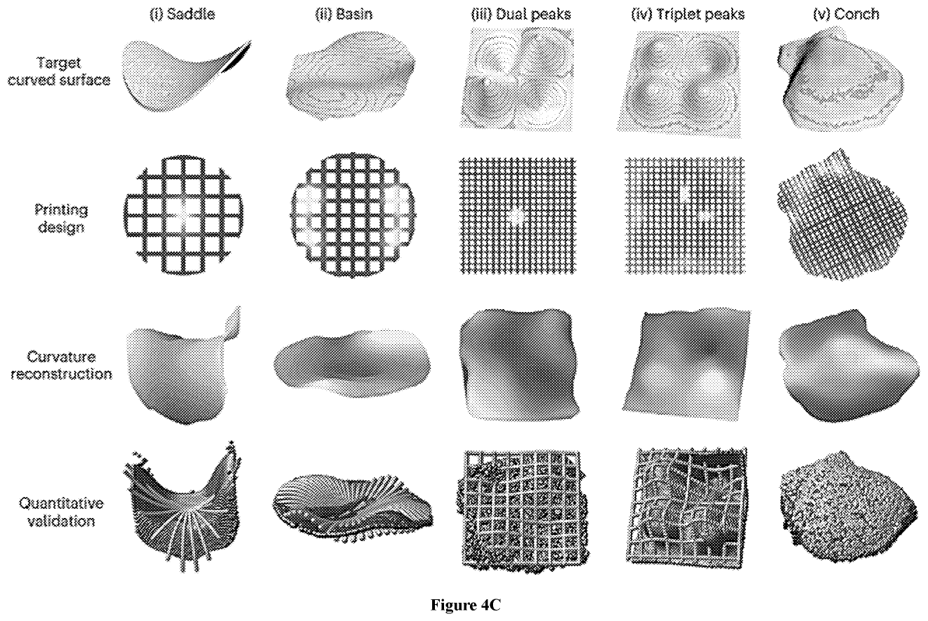

Designing an exposure pattern to precisely replicate a specific 3D surface with a complex curvature distribution is challenging to accomplish solely through intuition or FEA model-guided design (Supplementary Note 4). Thus, an inverse design strategy is developed to program ferromagnetic soft materials that are capable of transforming into target 3D curved surface under magnetic actuation. A hemispherical surface (Gaussian curvature K>0) is provided as an example in FIG. 4A. The hemispheric surface undergoes discretization using a uniform triangular mesh within modelling software, followed by flattening into a 2D meshed surface (u, v) with a circular boundary. Subsequently, the required photoexposure time for photodosage-based printing is deduced from the deformation gradient, as

$$t ( u , v ) = {( \frac{det {F ( u , v )}^{\frac{1}{3}} - 1.305}{7.342} )}^{\frac{- 1}{1.217}} \qquad Formula ( 5 )$$

Utilizing the calculated exposure pattern towards the hemispherical surface, the ferromagnetic soft material is fabricated through the proposed photodosage-based printing-assisted magnetization method.

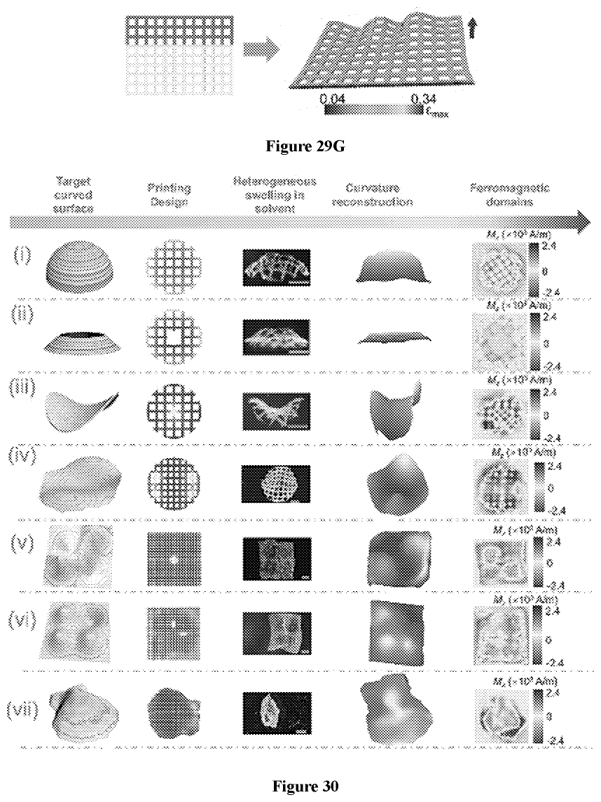

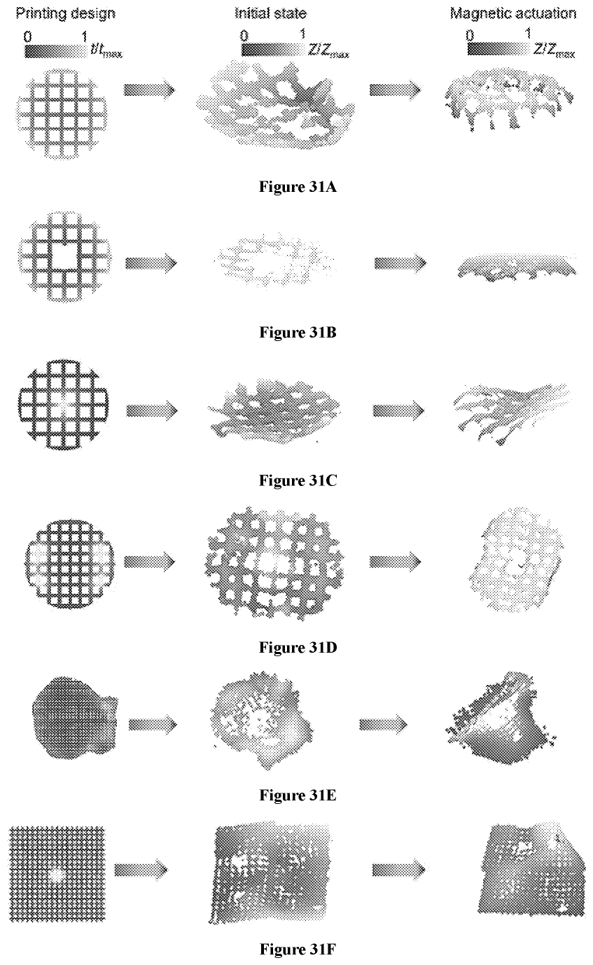

To amplify the deformation amplitude under magnetic actuation and attain improved replication of the target 3D curved surface, a microlattice design that effectively reduces the structural stiffness of ferromagnetic soft materials is incorporated. A resultant hemispherical surface with a rectangular microlattice design is shown in FIG. 4A. The 3D curved surface of the ferromagnetic soft material triggered by external magnetic field B is reconstructed using 3D digital microscope and microcomputed tomography techniques (FIGS. 30, 31A to 31G), demonstrating good consistency with the target hemispherical shape. In addition, the inverse design for another conical surface with K=0 is conducted, as shown in FIG. 4B. The resulting data of the 3D surface are quantitatively consistent with the target surface, which also validates the effectiveness of the inverse design strategy.

The capabilities of ferromagnetic soft materials in achieving more intricate 3D surfaces (FIG. 4C) is further presented. By using the inverse magnetization programming strategy, a saddle-shaped surface with K<0 and a basin surface that combines both negative and positive Gaussian curvatures are successfully constructed. The ability to regulate complex concave and convex microstructures within 3D surfaces enhances the range of accessible 3D morphologies. This invention demonstrate programmable surfaces defined by different Gaussian functions:

$$z = {\sum }_{{i = 1 , 2}_{j = 1 , 2}} {( - 1 )}^{i + j} a \times exp \{ - \frac{{[ x + {( - 1 )}^{i} {x}_{0} ]}^{2} + {[ y + {( - 1 )}^{i} {y}_{0} ]}^{2}}{{b}^{2}} \} , \qquad Formula ( 6 )$$

where i, j, a and b are parameters of the Gaussian functions, enabling the creation of configurations such as two peaks, two valleys or three peaks with one valley within a square boundary. The comparison of the 3D curved surface obtained through magnetic actuation and the target surface indicates that the developed inverse design strategy can accurately reconstruct ferromagnetic soft materials containing complex concave and convex microstructures. Finally, the universality of this approach is demonstrated by reproducing a conch surface with irregular boundaries triggered under magnetic actuation, which is almost impossible to achieve with traditional intuition-guided design methods.

### Applications of Programmed Ferromagnetic Soft Materials

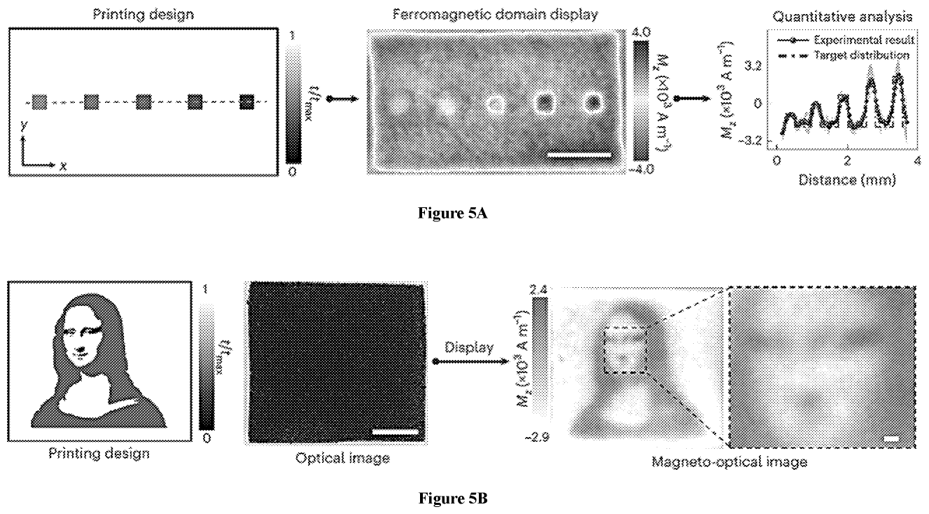

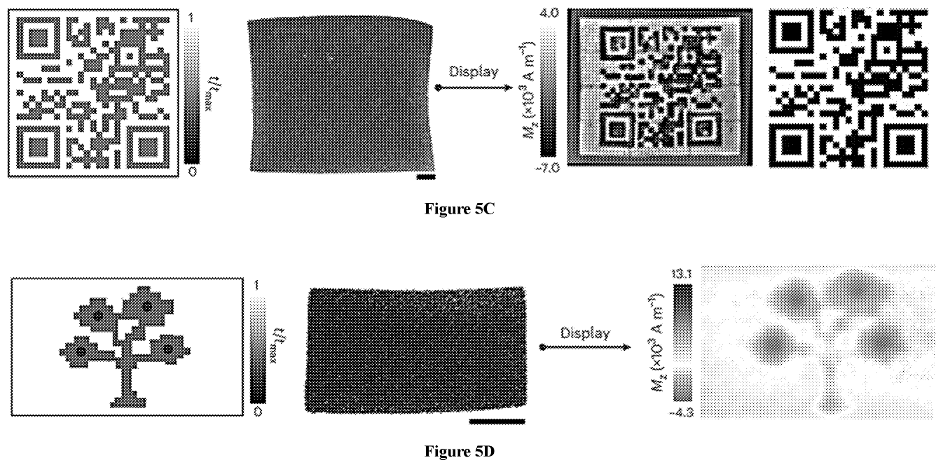

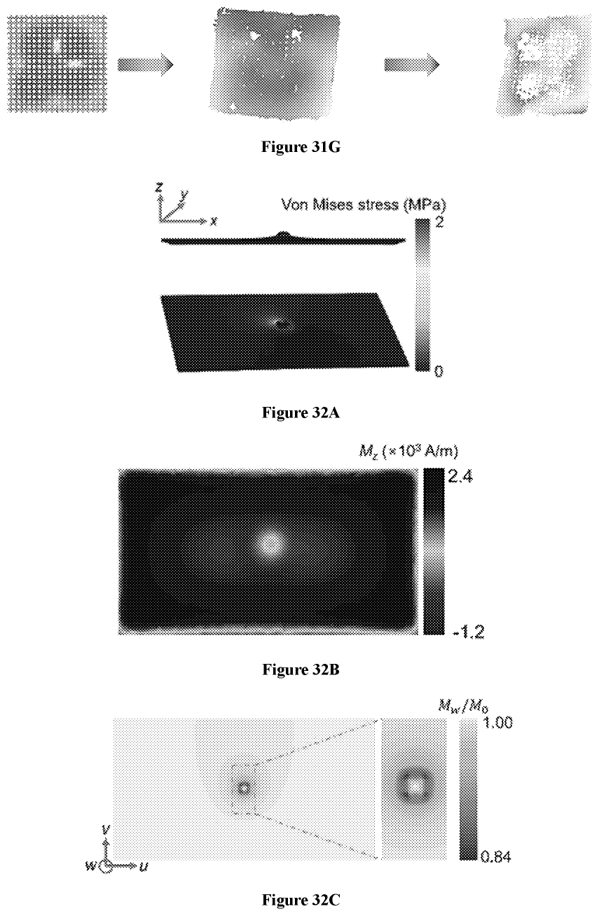

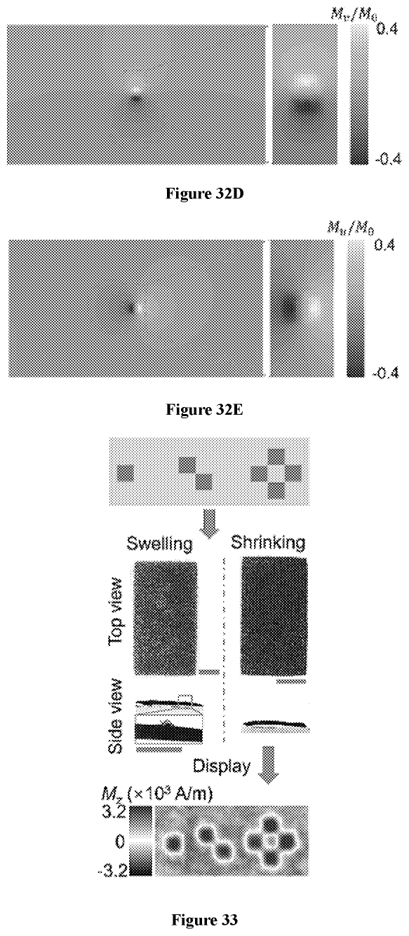

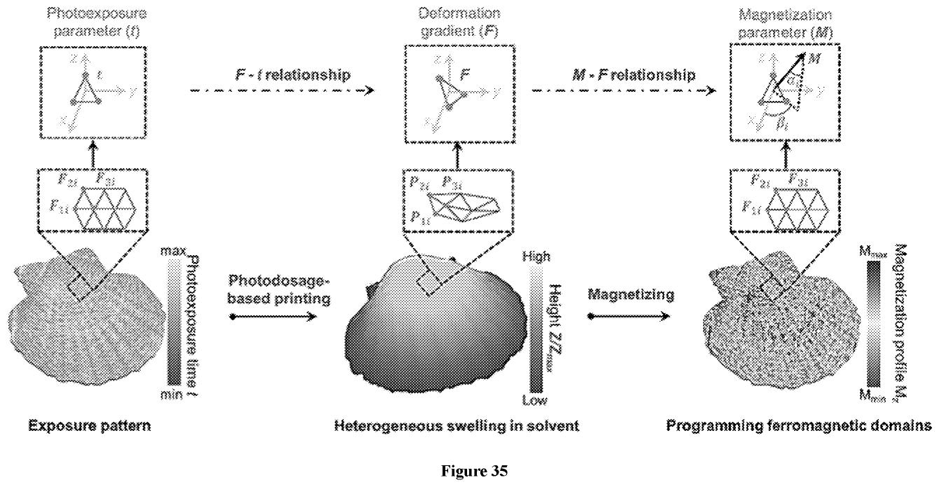

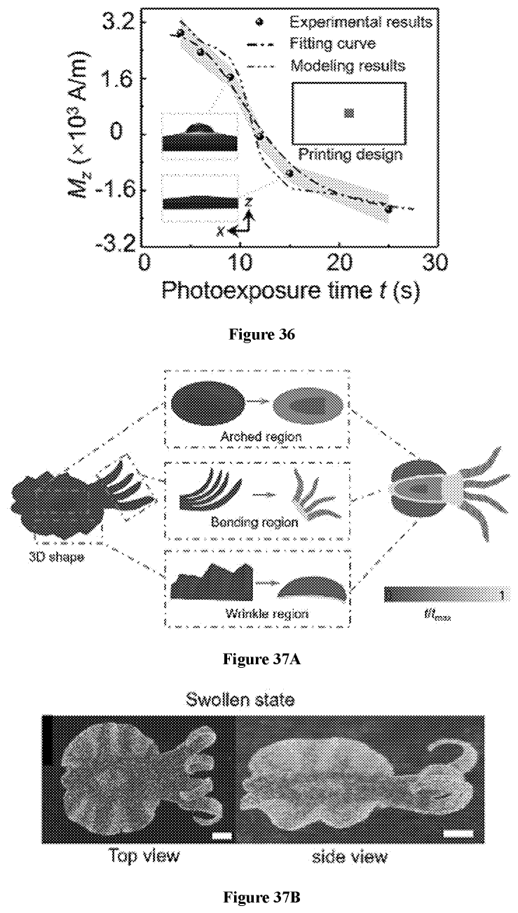

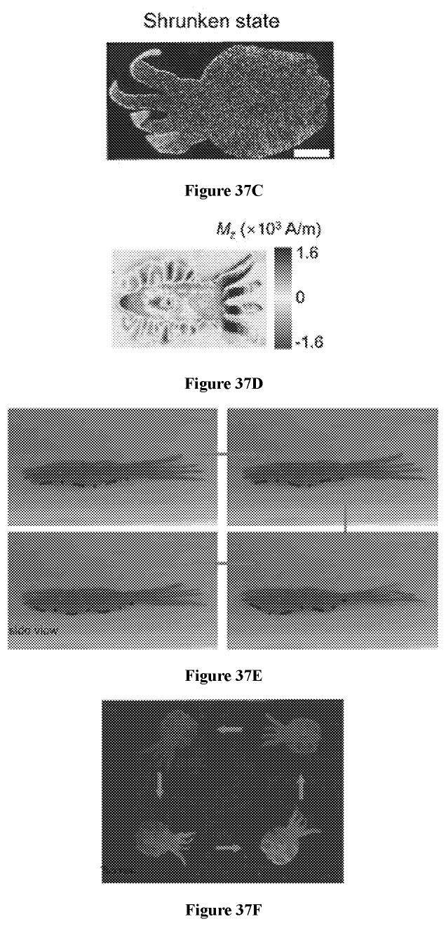

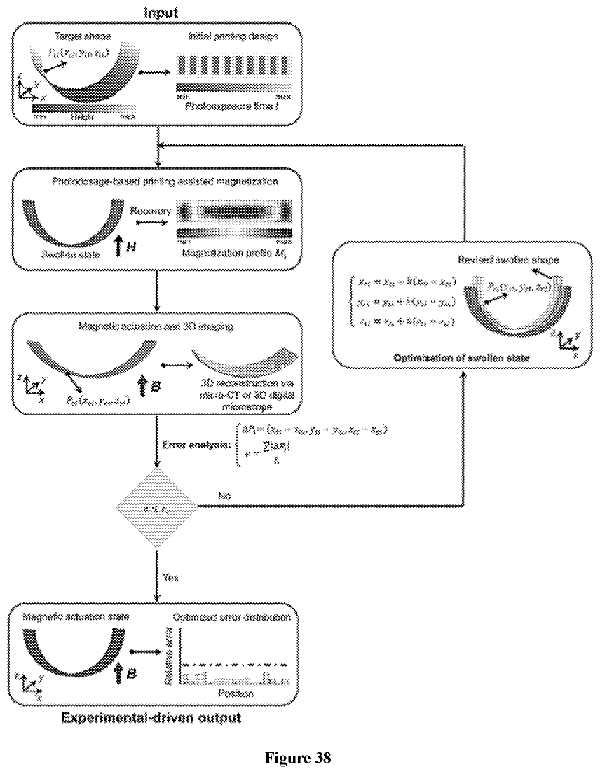

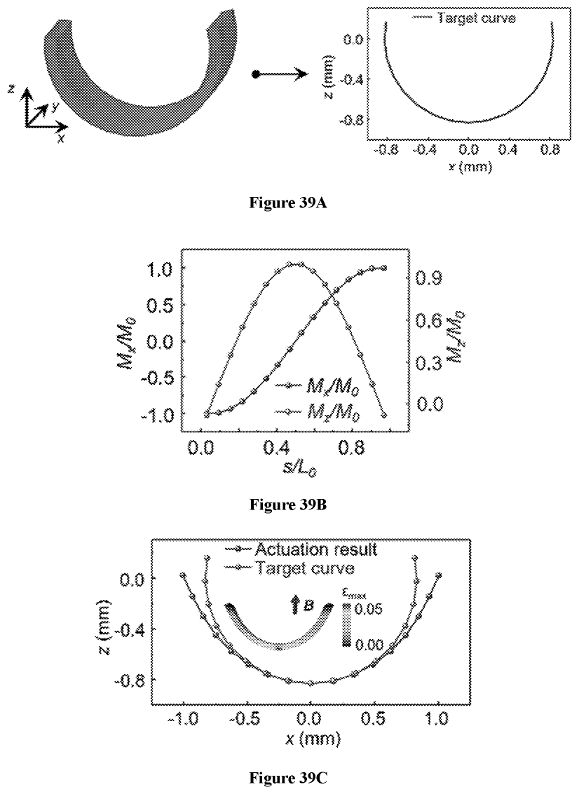

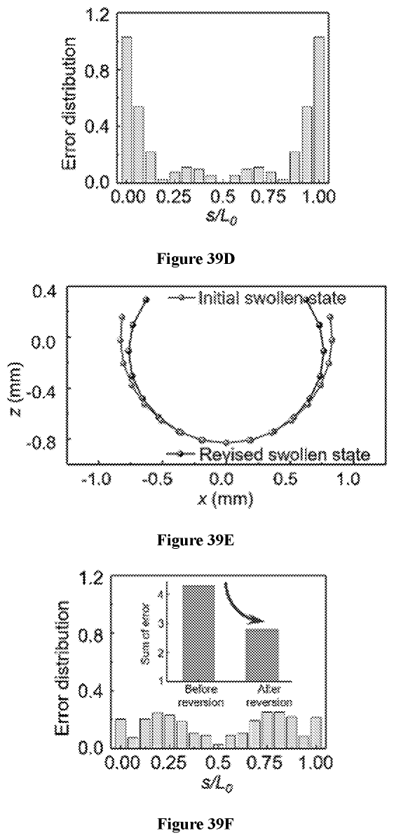

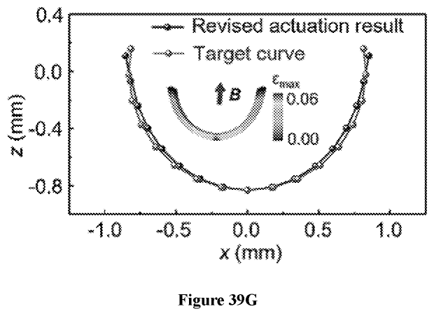

The precise programming of magnetization profiles is crucial for the functionality of ferromagnetic soft materials. Spatially discrete small squares (side length 100-300 m) are encoded into the hydrogel sheet with varied photoexposure times (FIG. 5A and FIGS. 32A to 32E, 33, 34A and 34B). Using the proposed FEA method, the deformation of the ferromagnetic soft material under solvent stimulation and the 3D-distributed magnetization profile (Mᵤ, Mᵥ and M_{w}, representing the components of local magnetization) programmed into the 2D film can be quantitatively analysed, thereby providing a means to derive the necessary exposure pattern (32A to 32E). As shown in FIG. 33, the ferromagnetic soft material developed by the proposed photodosage-based printing method exhibits a local bulge shape when immersed in deionized water. After magnetization with a pulsed magnetic field H and subsequent recovery to the undeformed state, the magnetic flux distribution in these localized regions becomes notably distinct from the surrounding areas, which can be clearly revealed by the magneto-optical sensor (Supplementary Note 7). To guide the design of information encryption in the ferromagnetic soft material, the relationship between the magnetization component along the z direction (M_{z}) and photoexposure time by printing a microsquare (low photoexposure dose) in a rectangle ferromagnetic soft material (high photoexposure dose) (FIGS. 35 and 36) is characterized. Microsquares with different photoexposure times yield a set of M_{z} values, which exhibit good consistency with the target design (indicated by the red dashed line), indicating the potential for magnetization programming by modulating the photoexposure time in each region of ferromagnetic soft material (FIG. 5A).

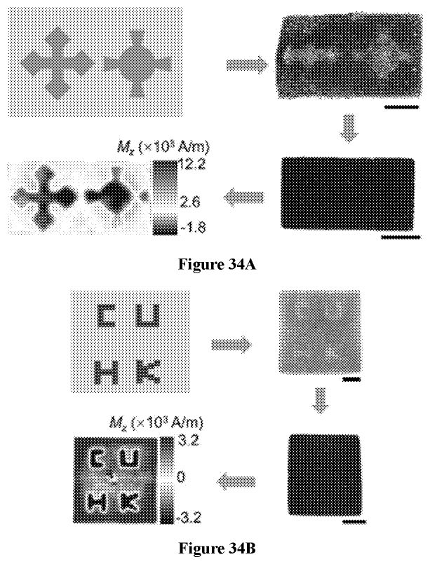

As a demonstration of information storage, facial details from the Mona Lisa painting are extracted and converted into the exposure pattern for photodosage-based printing (FIG. 5B). When examined through the magneto-optical sensor, the ferromagnetic soft material prominently exhibits the encoded image of the iconic Mona Lisa painting, allowing easy differentiation of the face, chest and background based on the difference in magnetic flux intensity. Furthermore, information storage for other micropatterns, including regular geometric shapes, ‘CUHK’ letters, a fruit tree pattern and a QR code, is conducted as shown in FIGS. 5C to 5E and FIGS. 34A and 34B, which demonstrate the effectiveness of the proposed method for large-capacity information encoding. In addition to geometric shapes, colour, as a form of complex information, holds potential for enhancing fault tolerance and security of information storage, contributing to the realms of confidentiality and anti-counterfeiting. The developed photodosage-based printing-assisted magnetization method allows precise modulation of the 3D ferromagnetic domain distribution in ferromagnetic soft materials, enabling multidimensional colour information storage. As depicted in FIG. 5E, the Starry Night pattern with vibrant colour information is successfully encoded into a 2D ferromagnetic film, validating the superiority of this invention in information storage compared with previous studies based on simple bidirectional ferromagnetic domain programming^{18,31}.

To demonstrate the capability to replicate 3D shapes with intricate geometric features, ferromagnetic soft material that can be transformed into a human face (FIGS. 5F to 5H) is developed. Prominent features include the nose, forehead and the left and right eye sockets, with the nose region exhibiting the highest Gaussian curvature. The central region between eyes displays delicate saddle features (K<0). The left and right eye sockets, aligned with the short axis of the saddle shape, undergo downward deformation (K>0). In addition, the nose and forehead, aligned with the long axis of the saddle shape, deform upwards (K>0). The digital model of the human face undergoes discretization and flattening using the proposed inverse design strategy, which yields the required exposure pattern for the ferromagnetic soft material. By using the photodosage-based printing-assisted magnetization method, complex and 3D-distributed hard-magnetic domains are programmed within the 2D surface (FIG. 5H), enabling the reconstruction of intricate facial features of the target human face when subjected to magnetic actuation. The magneto-optical results exhibit the encoded magnetization profiles of the eye and nose regions, highlighting the difficulty in achieving complex positions and orientations of ferromagnetic domains through intuitive design.

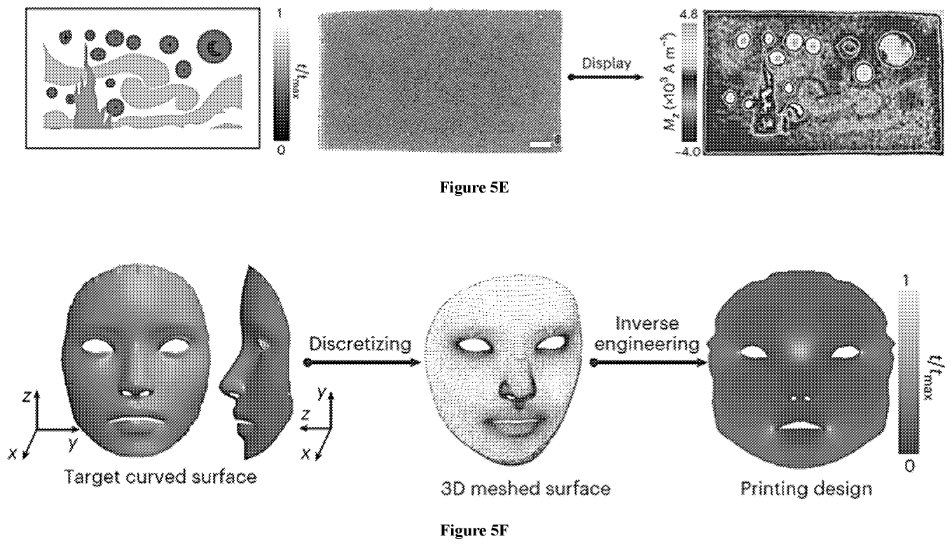

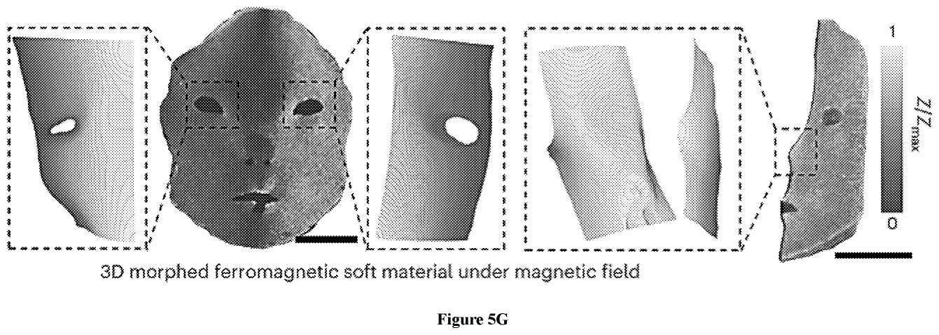

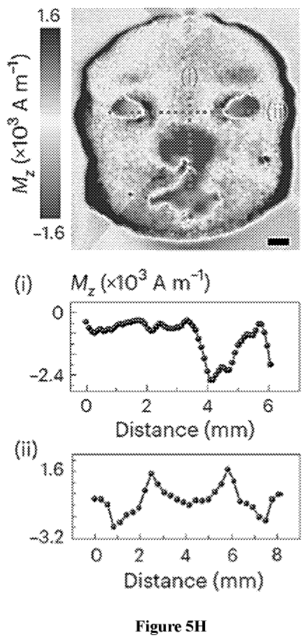

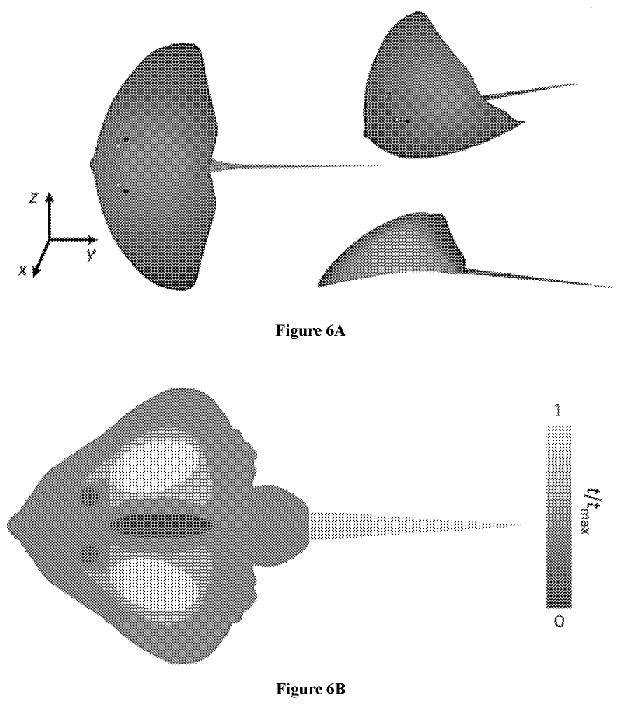

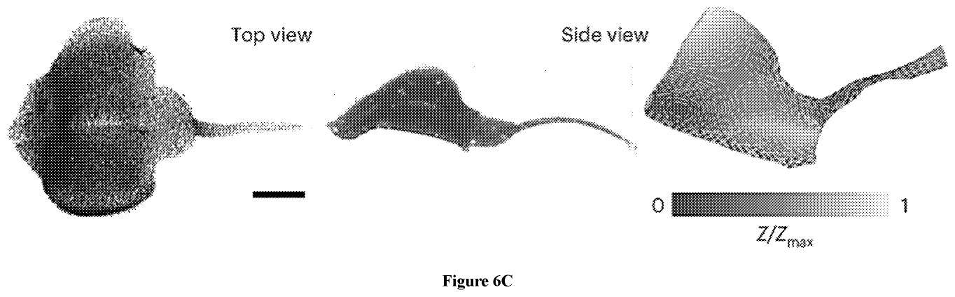

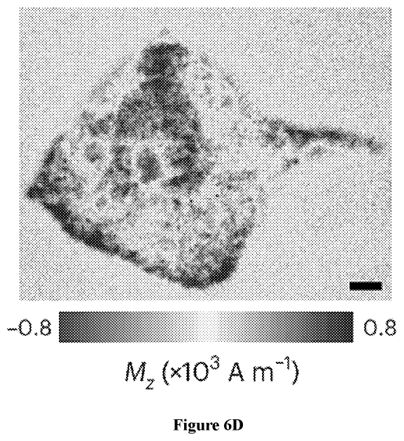

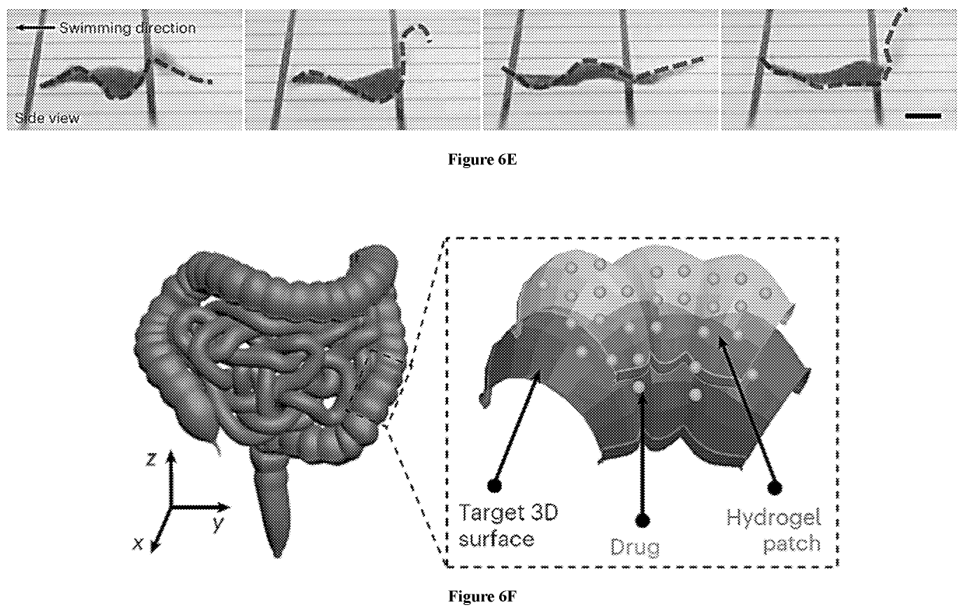

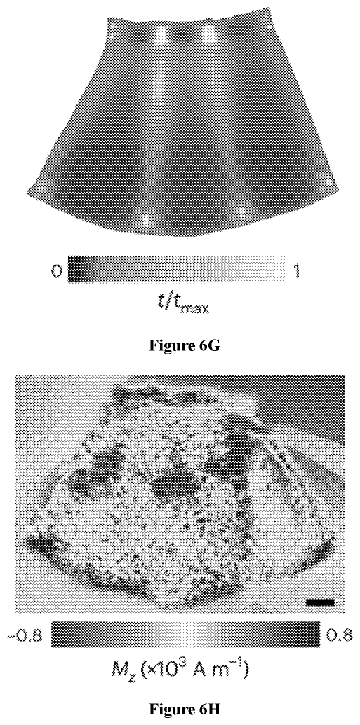

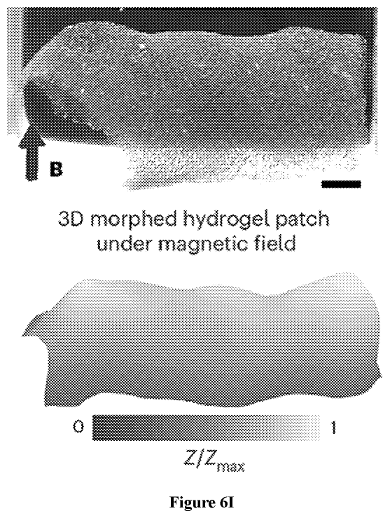

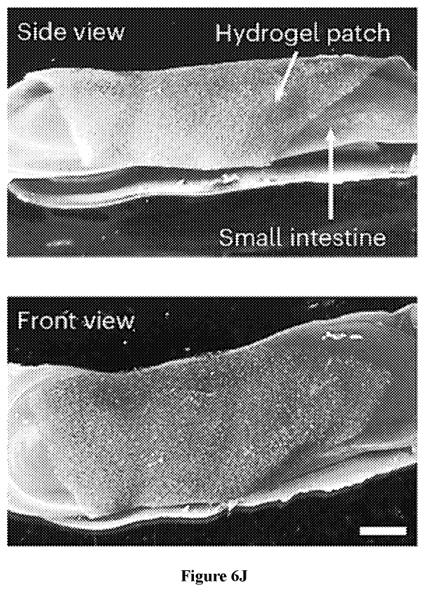

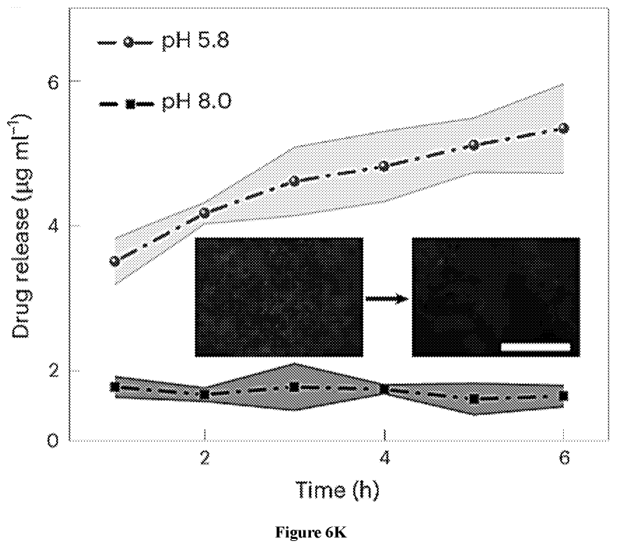

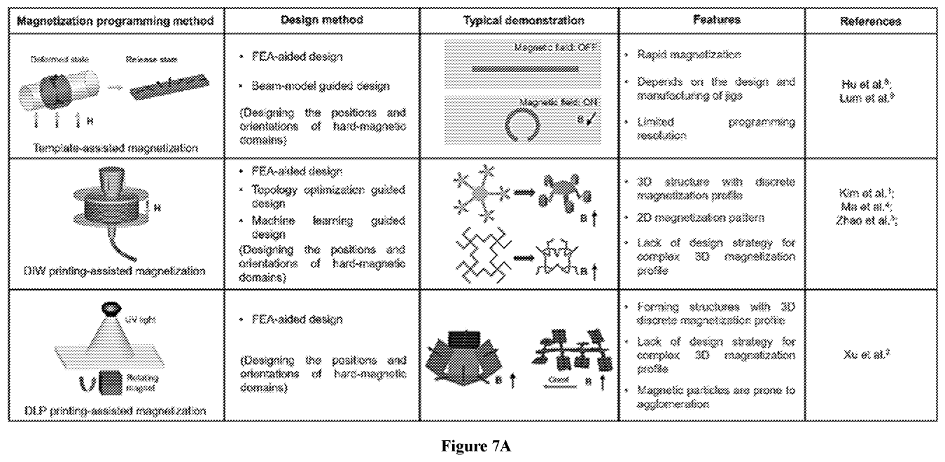

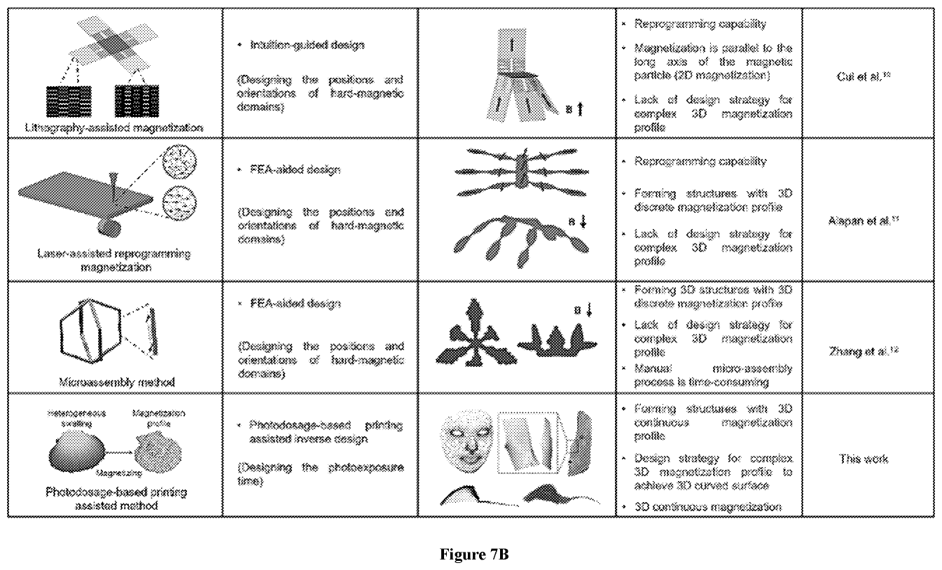

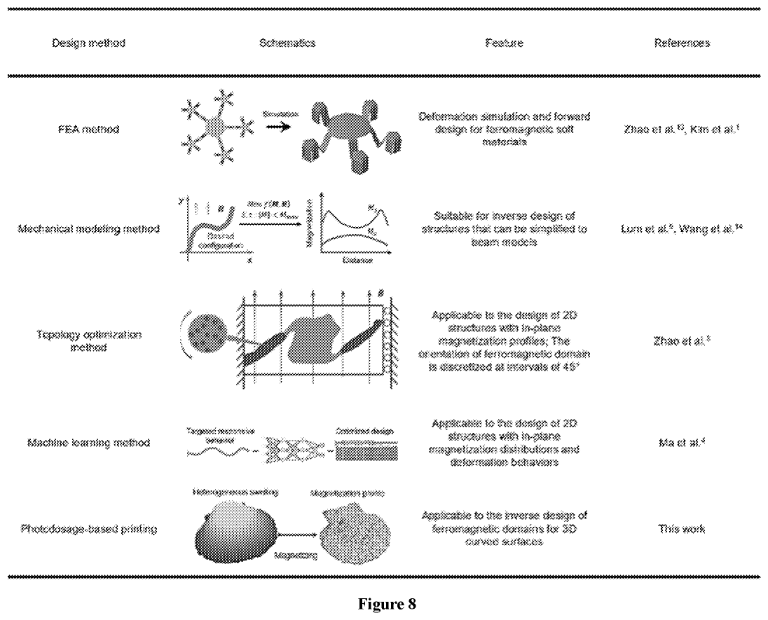

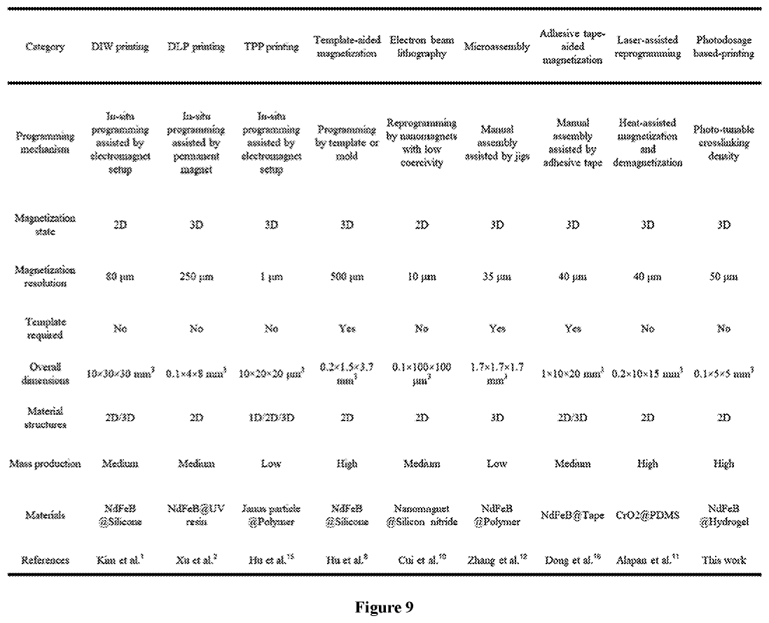

This magnetization programming method also offers an effective design strategy for constructing reconfigurable soft robots. Drawing inspiration from the deformation and locomotion modes of the stingray, a magnetically actuated soft robot (FIG. 6A) is developed. The stingray possesses a complex morphology, where the edges of the fan-shaped fins on both sides (K<0) deform upwards, the central area of the body (K>0) forms a convex surface, and the head and tail (K>0) display concave surfaces. As the stingray swims, undulating waves are generated and propagated along its fan-shaped fins. Based on the features of the 3D morphology and locomotion behaviour of the stingray, the requisite exposure pattern for photodosage-based printing is derived and subsequently fabricated a corresponding ferromagnetic soft robot (FIGS. 6B and 6C). When subjected to an oscillating magnetic field B, the ferromagnetic soft robot with the 3D-distributed magnetization profile (FIG. 6D) exhibits biomimetic locomotion behaviours, including the propagation of undulating waves and effective propulsion (FIG. 6E). In addition, this invention showcase the construction of a cuttlefish-inspired ferromagnetic soft robot, complete with wavy pectoral fins, flexible tails and a bulging body (FIGS. 37A to 37F). By using a dynamic magnetic field generated by an electromagnetic coil, the alternating transformation of the crest and trough positions in the wavy fin can be precisely controlled, demonstrating the potential of the proposed magnetization programming method in the bionic soft robotic field.

Finally, a drug-loaded medical patch that can adapt to the soft, wet and intricate exterior of the intestinal tract is demonstrated using the inverse ferromagnetic domain design scheme (FIG. 6F). Target drug delivery to the enteral environment faces challenges in improving delivery efficiency due to the presence of numerous unique wrinkles and slippery mucus on the intestinal surface. The inverse ferromagnetic domain programming method enables the personalized customization of medical patch according to the patient's specific intestinal morphology. Based on the 3D model of the diseased area within the intestine (acquired via medical imaging techniques, for example, computed tomography), the curved surface of the target intestine is discretized and flattened, yielding the necessary exposure pattern for photodosage-based printing (FIG. 6G). After the magnetization process, an engineered ferromagnetic medical patch with a specific magnetization profile (FIG. 6H) is prepared, which can rapidly transform into the 3D wrinkled morphology and tightly conform to the surface of the target intestine (FIGS. 6I and 6J) when subjected to an external magnetic field B. Through loading drug molecules (for example, doxorubicin) into the hydrogel matrix, the prepared medical patch can gradually release drugs to perform therapeutic tasks in a controllable manner (FIG. 6K).

### Discussion and Conclusion

This work presents an inverse design scheme to program the magnetization profile of ferromagnetic soft materials for controllable transformation into desired 3D curved surfaces under magnetic actuation. Ferromagnetic soft materials with 3D-distributed magnetization profile are prepared using a photodosage-based printing-assisted template-free magnetization method with superiority in both programming resolution and efficiency, where the required exposure pattern is inversely derived from target 3D surface. The proposed strategy transforms the hard-to-solve problem of arranging the positions and orientations of hard-magnetic domain into the straightforward modulation of crosslinking density, enabling ferromagnetic soft materials to morph into a wide range of target shapes from regular surfaces to intricate Gaussian surfaces. The demonstrations, including multidimensional information storage, biomimetic soft robots and conformal medical patches, highlight the promising application prospects of the proposed magnetization programming strategy.

There is still room for improving the inverse programming of ferromagnetic soft materials. First, in this work, this invention developed ferromagnetic soft materials with continuous magnetization distributions rather than the formation of discrete magnetization distributions. Each of these magnetization methods has its own advantages and disadvantages. The discrete magnetization method can produce enhanced deformation amplitudes owing to the rapid changes in spatial magnetization orientation. However, because voxels must be adjusted individually, specific processing equipment is required and the fabrication time is prolonged. Besides, the interaction between ferromagnetic particles during the fabrication process can lead to structural inhomogeneity, such as particle agglomeration. By contrast, the continuous magnetization method in this work may affect the deformation amplitude of magnetic actuation owing to the gradual change in ferromagnetic orientation between adjacent regions. However, it can complete magnetization in one step, offering good manufacturability and high forming efficiency. Future research could focus on metamaterial design to enhance the deformation capabilities and functionalities of ferromagnetic materials with continuous magnetization distributions. Second, the size and thickness of the ferromagnetic soft materials are determined by the irradiation area and photoexposure dose of the UV light source. In this work, a maximal horizontal area of ~50 mm×50 mm and a thickness of ~200 m could be achieved. By selecting a UV light source with a larger irradiation area and higher power, both the size and thickness of the ferromagnetic soft materials can be increased, thereby enhancing the mass production capabilities. Third, while the swollen shape of ferromagnetic soft materials can theoretically resemble the target shape by modulating the spatial crosslinking density, a deviation may occur between the actual actuation shape and the swollen shape during magnetic actuation. Although increasing the strength of the actuating magnetic field and minimizing the storage of elastic potential energy in ferromagnetic soft materials may help to ease the problem to some extent, the target 3D shape is nearly reached but not fully. In the future work, it is planned to develop a feedback-driven compensation scheme (the framework can be found in Supplementary Note 8 and FIGS. 38, 39A to 39G), aiming to minimize the deviation between the magnetic actuation shape and the target shape. In addition, advanced data processing technologies, such as machine learning, can be integrated to enable self-evolving designs and enhance performance in emulating complex living organisms. Besides, functional modifications such as incorporating biodegradable, self-healing or conductive polymers into hydrogel networks can be conducted to endow ferromagnetic soft material with enhanced capabilities, facilitating the opening of avenues for their applications in various engineering fields.

### Methods

### Materials

The chemicals of AAc (99%), MAAc (99%), ethyl lactate (98%), polyvinylpyrrolidone (average molecular weight≈1,300,000 g mol⁻¹), glycerol, 1H,1H,2H,2H-perfluorodecanethiol, sodium hydroxide and ammonia solution (25-28%), and N,N-dimethylformamide (99.9%) were obtained from Aladdin Chemicals. Irgacure 819 and ethoxylated(6)trimethylolpropane triacrylate (TMP6EOTA, 98%) were purchased from Curease Chemical. N-isopropylacrylamide (NIPAAm, 98%) was obtained from TCI Chemicals. PBS was obtained from Beijing Solarbio Science & Technology. Tetraethylorthosilicate (TEOS) was purchased from J&K Scientific. NdFeB microparticles with an average size of 5 μm (LW-BA(16-7A)-2000) were purchased from Guangzhou Xinnuode. All chemicals were used without further purification.

### Synthesis of Ferromagnetic Particles

The SiO₂ layer of the NdFeB particle was formed through the hydrolysis and polycondensation of TEOS. The procedure involves evenly dispersing 18 g NdFeB particles and 27 ml ammonia solution in 450 ml ethanol through vigorous stirring. After this, 1.2 ml TEOS is added to the mixture, and stirring is continued for a duration of 12 h.

### Synthesis of Gel Precursors

Initially, functional monomers of the ferromagnetic hydrogel (2 g NIPAAm, 0.5 ml AAc and 0.5 ml MAAc) were dispersed in 1.5 ml mixture of ethyl lactate and glycerol (mass ratio 1:3) through vigorous stirring. After this, the crosslinker (0.65 ml TMP6EOTA) and photoinitiator solution (0.15 ml Irgacure 819/N,N-dimethylformamide, 5 wt %) were added to the above mixture. To prevent the rapid sinking of NdFeB@SiO₂ particles during the photodosage-based printing, 0.3 g polyvinylpyrrolidone was added to increase the viscosity of the hydrogel resin, which was then mixed with NdFeB@SiO₂ particles at a weight ratio of 1:1. The ferromagnetic hydrogel resin was stored under ambient conditions free from UV light exposure, before its usage. The hydrogel precursor and ferromagnetic microparticles were thoroughly mixed at 2,000 rpm for 2 min using a planetary centrifugal mixer before each printing process. The solvent-responsive behaviour of the ferromagnetic hydrogel mainly originates from the carboxylic groups of AAc and MAAc. The combination of AAc and MAAc was performed to balance the hydrophilic and hydrophobic groups of hydrogel network to some extent, facilitating to modulate the swelling behaviours of hydrogel. NIPAAm was added to increase the volume concentration of monomers in hydrogel precursor, which increases the mechanical strength of hydrogel after photopolymerization. This helps to prevent the ferromagnetic hydrogel from becoming too soft or fragile, especially for the samples with low photoexposure time.

### Treatment of Glass Substrate

A thin silver film was deposited to a glass substrate by E-beam evaporation (EB-600, IVS). Subsequently, the glass substrate was soaked in the mixed solution of 1H,1H,2H,2H-perfluorodecanethiol and ethanol (volume ratio 1:100) for 20 min to obtain a hydrophobic surface that facilitates the removal of the printed hydrogel structure.

### Procedures of Photodosage-Based Printing

The prepared ferromagnetic hydrogel resin was deposited onto the aforementioned glass substrate, on which the ferromagnetic soft material was fabricated with a commercially available projection microstereolithography system (NanoArch S130, BMF Precision). Throughout the photodosage-based printing process, a light-emitting diode emitting a 405 nm wavelength was used to develop ferromagnetic soft materials with heterogeneous crosslinking densities. After the photodosage-based printing, the resulting ferromagnetic soft materials were treated with ethanol for 10 min and immersed in ultrapure water for heterogeneous swelling. The power density and wavelength of the UV light source were 50 mW cm⁻² and 405 nm, respectively.

### Magnetization of Ferromagnetic Soft Materials

For the magnetization of ferromagnetic soft material, a magnetizer (MA 2030, Shenzhen Jiuju Industrial Equipment) was used to magnetize the sample. The magnetizer mainly consisted of an electromagnetic coil and a high-capacity capacitor. After fully charging the capacitor, the capacitor was suddenly discharged, which then generated a large transient current to flow through the electromagnetic coil, leading to the production of a strong magnetic field H (~2.5 T). This magnetic field was uniform in the inner space (diameter 20 mm) of the electromagnetic coil, so millimetre-sized sample could be put inside the electromagnetic coil in advance for magnetization. In this invention, the pulsed magnetic field H was kept constant for all samples.

### Doxorubicin Load for Ferromagnetic Medical Patch

Doxorubicin (DOX) was initially dissolved in deionized water at a concentration of 1 mg ml⁻¹. A ferromagnetic medical patch was then immersed in the DOX solution for a duration of 2 h, allowing drug loading. After this, the medical patch was transferred to solutions with varying pH levels and left to release DOX for a period ranging from 2 to 6 h. The release of drugs was quantified using a UV-visible spectrophotometer (Hitachi U2910), while the standard curve for drug concentration was also measured using the same instrument.

### FEA-Aided Design

The deformation behaviour of ferromagnetic soft materials was stimulated in response to solvent and magnetic field through the user-element subroutine in ABAQUS. For solvent-responsive behaviour, on the basis of the mechanical model of the hydrogel established in Supplementary Note 5 and the measured parameters (swelling ratio, Nᵥ and χ) in FIGS. 2B and 2C, the corresponding subroutine of hyperelastic material was developed to analyse the deformation of ferromagnetic soft materials under a given exposure pattern. For magnetic response behaviour, the distribution of 3D ferromagnetic domains in ferromagnetic soft material was analysed according to the method proposed in Supplementary Note 7. Considering the asymmetry of the Cauchy stress caused by the magnet torque, a custom-made eight-node brick element was adopted to handle the nine components of the Cauchy stress tensor. The developed user subroutine of ferromagnetic soft material was used to simulate the morphology transformation under magnetic stimulation.

### Characterization Techniques

A magneto-optical sensor (MagViewS, Matesy) was used to measure the magnetization profile of the ferromagnetic soft material. The variation in the maximum and minimum values of M_{z} between different ferromagnetic soft materials was caused by the different shape deformation modes and deformation amplitudes of samples at the swollen state. Moreover, the range of M_{z} values in the colour bar of each printed sample was manually adjusted, aiming to better display the magnetization profile information.

A mechanical tester (MACH-1 mechanical tester v500cst, MA008) was adopted to measure the mechanical properties of the ferromagnetic soft material. For the mechanical test, a series of disc-shaped ferromagnetic hydrogels (diameter 1.7 mm, thickness 0.5 mm) with different photoexposure times was printed as the test samples. Three samples from each photoexposure time group were used to evaluate their stress-strain curves during compression (compression velocity 0.01 mm s⁻¹). To eliminate the errors caused by insufficient contact at the initial stage, the linear range after the strain reached 0.15 was selected to calculate the elastic modulus.

The magnetic hysteresis of the printed ferromagnetic soft material was obtained by a PPMS model 6000 Quantum Design vibrating sample magnetometer. For the vibrating sample magnetometer test, dry ferromagnetic samples were used. The temperature during the test was 300 K, and the magnetic field intensity changed from −25,000 to 25,000 Oe with a speed of 20 Oe s⁻¹.

A digital microscope (Hirox RH-2000 Digital Microscope) and a 3D X-ray microscopy (Zeiss Versa 515) were used for the 3D reconstruction of curved surfaces.

The solvent content of the ferromagnetic hydrogel was measured using the gravimetric method. Before measurement, filter paper was used to remove the surface solvent, and the sample was dried in a vacuum oven at 100° C. until it no longer lost weight. The solvent content (SC) of the hydrogel was calculated using the following equation:

$$S C = ( {W}_{1} - {W}_{2} ) / {W}_{1} , \qquad Formula ( 7 )$$

where W₁ and W₂ are the masses of the hydrogel before and after drying, respectively.

### Statistical Analysis

A two-sided Student's t-test was conducted for FIG. 6K, with P<0.05 considered statistically significant (P=0.0085, 95% confidence interval).

### Supplementary Information

### Supplementary Note 1 Magnetization Programming of Ferromagnetic Soft Materials

During the fabrication stage in this invention, unmagnetized neodymium iron boron (NdFeB) microparticles are thoroughly mixed with the hydrogel precursor to create the printing resin, which is photopolymerized to obtain the soft material. The details of NdFeB microparticles are shown in FIGS. 11A and 11B, indicating the magnetic microparticles exhibit irregular shapes and hard-magnetic properties. A single unmagnetized NeFeB microparticle consists of many randomly distributed magnetocrystallines, making it possess zero net magnetization. Subsequently, the printed soft material is put in a solvent, allowing for heterogeneous swelling to form the designed 3D shape, and then subjected to magnetization by applying a strong pulsed magnetic field H (~2.5 T). At this moment, the randomly distributed magnetocrystallines within each NdFeB microparticle are aligned by the magnetizing field H (FIG. 11C), inducing the generation of nonzero net magnetization. After the pulsed magnetic field H is removed, the magnetization left behind in NdFeB microparticle is the so-called remanence. This process only involves the orientation change of magnetocrystallines within NdFeB microparticle, while the rotation of NdFeB microparticle as a whole inside hydrogel network does not happen. Finally, the soft material with magnetized NdFeB microparticles is recovered to the initial flat shape, which can be magnetically actuated to form the designed 3D shape via the dipolar interactions between the remanence of soft material and the actuating magnetic field.

The in-situ observation of magnetization process of the ferromagnetic soft material shows that the positions and orientations of NdFeB microparticles do not change before and after magnetization for both low and high exposure samples, indicating that the hard-magnetic particles are not rotated or moved during the magnetization process. In addition, the mass of ferromagnetic soft materials does not change during the swelling and magnetization process, which is applicable for the samples printed with various exposure dosages. This suggests that NdFeB microparticles would not diffuse or migrate out of the hydrogel network for both low and high exposure samples.

Although there are many works using the rotation of magnetized particles to program the magnetization^{47,48}, the magnetization programming method in this invention is different. In this invention, after the photodosage-based printing, the ferromagnetic soft material and the embedded NdFeB microparticles are actually unmagnetized, displaying zero net magnetization. During the heterogeneous swelling process, the embedded NdFeB microparticles are rotated due to the shape deformation of the hydrogel ribbon (e.g., bending). When a pulsed magnetic field H is applied, the positions and structural orientations of NdFeB microparticles are not changed, while the magnetocrystallines within microparticles are aligned by the magnetic field H, making the swollen ferromagnetic soft material become magnetized and display a nonzero net magnetization along the field direction of H. Subsequently, ferromagnetic soft material is taken out from the solvent and recovered to the flat shape, which rotates the embedded NdFeB microparticles back to the initial orientations. This leads to the change of the magnetization directions in different regions of ferromagnetic soft material. If an actuating magnetic field is applied with an upward direction (i.e., along z direction), the ferromagnetic soft material will morph into the shape of the swollen state due to the dipolar interactions between the magnetizations in different hydrogel regions and actuating magnetic field. In other words, the “imprinting” of this swelling shape is magnetically on the flat ribbon. Through adjusting the swollen shape of ferromagnetic soft material via controlling the photoexposure time, various magnetization directions can be encoded in the hydrogel film, thus achieving the magnetization programming in this invention.

To illustrate the regulation of magnetization directions in different regions of ferromagnetic soft material, a magneto-optical sensor is used to scan the horizontal (x-y) plane of hydrogel film. It can only detect the magnetic field perpendicular to the sensor surface, while the magnetic field parallel to the sensor surface cannot be detected. Therefore, when magneto-optical sensor is used to characterize our ferromagnetic soft materials, the tested values actually refer to the local magnetic field component along z direction. For the ferromagnetic soft materials in our work, the magnitude of magnetization M is uniform in every region. But due to the variations in magnetization directions, the magnetization component perpendicular to the sample surface (i.e., along z direction) becomes different, causing the magneto-optical sensor to display different values of M_{z}. M_{z} is measured to be positive when the direction of magnetization is pointed to the positive direction of z-axis, and otherwise negative.

In summary, direct observations of the magnetization process and mass change of ferromagnetic soft material indicate that NdFeB microparticles do not experience notable rotation or leakage during swelling and magnetization states. The formation and programming of anisotropic magnetization in ferromagnetic soft materials are determined by their deformation shapes during swollen/magnetization states.

### Supplementary Note 2 Implementation of Photodosage-Based Printing

Photodosage-based printing was performed using a commercial Projection Micro Stereolithography (PμSL) 3D Printer (NanoArch S130, BMF Precision, China). UV LED with a wavelength of 405 nm is used as the light source. A 2D exposure pattern (color pattern) is converted into a grayscale pattern using the developed MATLAB code. Grayscale images consist of shades of gray, ranging from black (RGB value: 0) at the weakest intensity to white (RGB value: 255) at the strongest intensity. The RGB values of the grayscale pattern are proportional to the photoexposure time. While, the 3D printer cannot directly process grayscale pattern. We decompose the grayscale pattern into N black-and-white images by setting a uniform step size, as shown in Formulae (8) and (9), and FIG. 12.

$$B W ( i , u , v ) = \{ \begin{matrix}255 , if RGB ( u , v ) > Δ G \times ( i - 1 ) + min ( RGB ( u , v ) ) \\ 0 , else\end{matrix} \qquad Formula ( 8 )$$

$$Δ G = \frac{max ( RGB ( u , v ) ) - min ( RGB ( u , v ) )}{N} \qquad Formula ( 9 )$$

(u, v) represents the coordinate of the 2D pattern. BW(i, u, v) represents the RGB value (0 or 255) at the point (u, v) in the i-th black-and-white image.

### Supplementary Note 3 Algorithm for Inverse Design

The algorithm for designing printing patterns based on target shapes is given as follows:

1. Obtain triangular meshes of 3D surfaces: 3D modeling software (Solidworks or 3Ds Max) is used to reconstruct the target 3D surface, and triangular mesh is used to discretize the surface. For the i-th triangular grid, its grid point coordinates are P₁ᵢ=[x₁(i) y₁(i) z₁(i)], P₂ᵢ=[x₂(i) y₂(i) z₂(i)], P₃ᵢ=[x₃(i) y₃(i) z₃(i)] respectively. The grid point information set of the target three-dimensional surface is Q={[P₁₁ P₂₁ P₃₁], [P₁₂ P₂₂ P₃₂] . . . [P_{1N} P_{2N} P_{3N}]}.

2. The mapping relationship between the 3D surface and the 2D plane is established based on the map theory. Boundary First Flattening (BFF) algorithm is used to expand the surface conformally to the plane. On the premise that the boundary is known, the mapping relationship can be determined by Cherrier formula and Poincare-Steklov operator, and extended to the whole area. For the i-th triangular mesh, the grid point of its 3D surface mapping on the 2D plane is F₁ᵢ=[u₁(i) v₁(i)], F₂ᵢ=[u₂(i) v₂(i)], F₃ᵢ=[u₃(i) v₃(i)].

$$i = 1 : N , \{ {P}_{1 i} , {P}_{2 i} , {P}_{3 i} \} \to \{ {F}_{1 i} , {F}_{2 i} , {F}_{3 i} \} : Q \to C \qquad Formula ( 10 )$$

3. The deformation rate of a triangular mesh is calculated. Custom-designed algorithm in MATLAB software is proposed to calculate the deformation rate of the 2D plane triangular mesh and its corresponding 3D surface triangular mesh:

$$m ( i ) = \frac{1}{2} ( \vert {F}_{1 i} {F}_{2 i} \vert + \vert {F}_{1 i} {F}_{3 i} \vert + \vert {F}_{2 i} {F}_{3 i} \vert ) \qquad Formula ( 11 )$$

$$n ( i ) = \frac{1}{2} ( \vert {P}_{1 i} {P}_{2 i} \vert + \vert {P}_{1 i} {P}_{3 i} \vert + \vert {P}_{2 i} {P}_{3 i} \vert ) \qquad Formula ( 12 )$$

$$σ ( i ) = \sqrt{\frac{n ( i ) ( n ( i ) - \vert {P}_{1 i} {P}_{2 i} \vert ) ( n ( i ) - \vert {P}_{1 i} {P}_{3 i} \vert ) ( n ( i ) - \vert {P}_{2 i} {P}_{3 i} \vert )}{m ( i ) ( m ( i ) - \vert {F}_{1 i} {F}_{2 i} \vert ) ( m ( i ) - \vert {F}_{1 i} {F}_{3 i} \vert ) ( m ( i ) - \vert {F}_{2 i} {F}_{3 i} \vert )}} \qquad Formula ( 13 )$$

$$det F ( i ) = {σ ( i )}^{3} \qquad Formula ( 14 )$$

4. Exposure pattern for photodosage-based printing is calculated. The deformation rate of the grid is smoothed and interpolated to obtain F(u, v), and the deformation coefficient required by the material is calculated in MATLAB software.

$$t ( u , v ) = t ( F ( u , v ) ) \qquad Formula ( 15 )$$

Custom-designed code to calculate the deformation rate:

```
%%%%%%%%%%
fid = fopen(‘mesh.txt’,‘r’);
content = textscan(fid,‘%s');
fclose(fid);
data=content{1,1};
x=[ ];
y=[ ];
z=[ ];
u=[ ];
v=[ ];
w=[ ];
f1_1=[ ];
f1_2=[ ];
f1_3=[ ];
f2_1=[ ];
f2_2=[ ];
f2_3=[ ];
S1=[ ];
S2=[ ];
V=[ ];
i=1;
T_1=[ ];
T_2=[ ];
T_3=[ ];
while i<length(data)
  if isequal(data(i),cellstr(‘v’))
    x=[x; str2num(cell2mat(data(i+1)))];
    y=[y; str2num(cell2mat(data(i+2)))];
    z=[z; str2num(cell2mat(data(i+3)))];
    i=i+4;
  elseif isequal(data(i),cellstr(‘vt’))
    u=[u; −str2num(cell2mat(data(i+1)))];
    v=[v; str2num(cell2mat(data(i+2)))];
    i=i+3;
      elseif isequal(data(i),cellstr(‘f’))
    F_1=split(cell2mat(data(i+1)),‘/’);
    F_2=split(cell2mat(data(i+2)),‘/’);
    F_3=split(cell2mat(data(i+3)),‘/’);
    i=i+4;
    f1_1=[f1_1; str2num(cell2mat(F_1(1)))];
    f1_2=[f1_2; str2num(cell2mat(F_2(1)))];
    f1_3=[f1_3; str2num(cell2mat(F_3(1)))];
    f2_1=[f2_1; str2num(cell2mat(F_1(2)))];
    f2_2=[f2_2; str2num(cell2mat(F_2(2)))];
    f2_3=[f2_3; str2num(cell2mat(F_3(2)))];
  end
end
%%%%%%%%%%
C1_x=mean([x(f1_1) x(f1_2) x(f1_3)],2);
C1_y=mean([y(f1_1) y(f1_2) y(f1_3)],2);
C1_z=mean([z(f1_1) z(f1_2) z(f1_3)],2);
C2_u=mean([u(f2_1) u(f2_2) u(f2_3)],2);
C2_v=mean([v(f2_1) v(f2_2) v(f2_3)],2);
%%%%%%%%%%
for i=1:length(f1_1)
  a1=sqrt( ( (x(f1_1(i))−x(f1_2(i))).\hat{ }2 + (y(f1_1(i))−y(f1_2(i))).\hat{ }2 + (z(f1_1(i))−
  z(f1_2(i))).\hat{ }2));
  b1=sqrt( ( (x(f1_1(i))−x(f1_3(i))).\hat{ }2 + (y(f1_1(i))−y(f1_3(i))).\hat{ }2 + (z(f1_1(i))−
  z(f1_3(i))).\hat{ }2));
  c1=sqrt( ( (x(f1_3(i))−x(f1_2(i))).\hat{ }2 + (y(f1_3(i))−y(f1_2(i))).\hat{ }2 + (z(f1_3(i))−
  z(f1_2(i))).\hat{ }2));
  a2=sqrt( ( (u(f2_1(i))−u(f2_2(i))).\hat{ }2 + (v(f2_1(i))−v(f2_2(i))).\hat{ }2) );
  b2=sqrt( ( (u(f2_1(i))−u(f2_3(i))).\hat{ }2 + (v(f2_1(i))−v(f2_3(i))).\hat{ }2) );
  c2=sqrt( ( (u(f2_3(i))−u(f2_2(i))).\hat{ }2 + (v(f2_3(i))−v(f2_2(i))).\hat{ }2) );
  p1=0.5*(a1+b1+c1);
  p2=0.5*(a2+b2+c2);
  S1(i)=sqrt( p1*(p1−a1)*(p1−b1)*(p1−c1));
  S2(i)=sqrt( p2*(p2−a2)*(p2−b2)*(p2−c2));
  V(i)=S1(i)/S2(i);
  T_1=[T_1; x(f1_1(i)) y(f1_1(i)) z(f1_1(i)) u(f2_1(i)) v(f2_1(i))];
  T_2=[T_2; x(f1_2(i)) y(f1_2(i)) z(f1_2(i)) u(f2_2(i)) v(f2_2(i))];
  T_3=[T_3; x(f1_3(i)) y(f1_3(i)) z(f1_3(i)) u(f2_3(i)) v(f2_3(i))];
end
%%%%%%%%%%
figure
subplot(1,2,1)
plot3(x,y,z,‘.’)
xlabel(‘x’)
ylabel(‘y’)
zlabel(‘z’)
axis equal
hold on
subplot(1,2,2)
plot(u,v,‘.’)
xlabel(‘x’)
ylabel(‘y’)
axis equal
hold on
figure
plot3(C2_u,C2_v,V’,‘.’)
hold on
Vi=griddata(C2_u,C2_v,V’,u,v);
plot3(u,v,Vi,‘r.’)
figure
[xq,yq]=meshgrid(linspace(min(u)−0.02,max(u)+0.02,300),linspace(min(v)−
0.02,max(v)+0.02,300));
vq=griddata(C2_u,C2_v,V’,xq,yq,‘v4’);
va=vq;
pcolor(xq,yq,va)
colormap(‘jet’)
caxis([min(V’) max(V’)])
hold on
plot(u,v,‘w.’,‘MarkerSize’,3)
colorbar
shading interp
axis equal
```

### Supplementary Note 4 Analysis of Computational Burden

In this invention, a scheme to achieve the inverse design of ferromagnetic soft materials using responsive hydrogels was developed, aiming to transform the challenging optimization problem of 3D-distributed hard magnetic domains into the straightforward modulation of soft material crosslinking density. To prove this statement, the current methods for designing ferromagnetic soft materials to achieve desired shapes are first summarized, including the finite element analysis (FEA) method, mechanical modeling, topology optimization, and machine learning, as detailed in FIG. 8.

The existing design methods for ferromagnetic soft materials face significant challenges in achieving the inverse design of complex magnetization profiles for target 3D surfaces. (1) The FEA-based method requires extensive trial and error, along with prior experience, to design complex ferromagnetic domains, classifying it as a forward design approach. (2) Due to the complexities of magnetic field-driven deformation, mechanical model-based design methods are limited to the ferromagnetic beam-like structures and are not effective in the inverse design of other 2D or 3D complex structures. (3) Topology optimization method developed by Zhao et al.⁴⁹ only focuses on 2D ferromagnetic soft materials with in-plane magnetization distribution. The orientations of ferromagnetic domains should be discretized at 45° intervals, making the topology optimization method inefficient when predicting the cases with more elaborate distribution of ferromagnetic domains. (4) Machine learning methods relying on obtaining a large dataset of magnetic actuation-induced deformation behaviors are also primarily used for analyzing 2D ferromagnetic soft materials. For example, the work by Ma et al.⁵⁰ studies the structures with in-plane 2D magnetization profiles and their corresponding in-plane deformations. There exist significant challenges for them in achieving the inverse design of ferromagnetic soft materials with 3D magnetization profiles.

Compared to existing methods, the approach proposed in this invention realizes the inverse design toward target 3D surfaces, which not only requires processing a smaller parameter space, but also does not depend on the acquisition of large datasets. A 3D curved surface, as shown in FIG. 13, is used as an example. When designing ferromagnetic soft materials based on the previously reported methods, the following steps are necessary: (i) discretize the target curved surface into n sub-regions; (ii) define the magnetization profile parameters (Mₓᵢ, M_{yi}, M_{zi}) for each sub-region i as indicated in Formulae (16) to (18). The orientation of the ferromagnetic domain is determined by (αᵢ,βᵢ), where M represents remanence of ferromagnetic domain after magnetization, αᵢ∈[0 360°] and βᵢ∈[0 360°].

$${M}_{xi} = M sin {α}_{i} cos {β}_{i} \qquad Formula ( 16 )$$

$${M}_{yi} = M sin {α}_{i} sin {β}_{i} \qquad Formula ( 17 )$$

$${M}_{zi} = M cos {α}_{i} \qquad Formula ( 18 )$$

(iii) determine the undeformed shape and magnetization distribution of the ferromagnetic soft materials using the previously reported optimization methods. If the approach of Zhao et al.⁴⁹ is used, i.e., assuming that the orientation angles (αᵢ, βᵢ) are discretized at 45° intervals, there are

$$( \frac{360 °}{45 °} \times \frac{360 °}{45 °} = 64 )$$

groups of possible magnetization parameters for each sub-region. Consequently, for the entire ferromagnetic material consisting of n sub-regions, we need to calculate 64ⁿ possible magnetization parameters for inverse design.

In contrast, if the approach of this invention is applied to the inverse design of ferromagnetic soft materials, only the photoexposure time for each sub-region needs to be determined after discretizing the target surface. As shown in the section “Photodosage-based printing-assisted template-free magnetization of ferromagnetic soft materials” and FIG. 2B, adjusting the photoexposure time from 4 to 25 seconds with an interval of 0.5 s is more than enough to modulate the crosslinking density and swelling behaviors of ferromagnetic soft materials. Therefore, there are

$$( \frac{25 s - 4 s}{0.5 s} = 42 )$$

possible photoexposure time parameters for each sub-region, and thus 42ⁿ possible photoexposure time distributions for the entire ferromagnetic soft material.

If the target curved surface is discretized into n=100 sub-regions, the parameters that need to be calculated in the approach of this invention only account for

$$( {( \frac{42}{64} )}^{100} = 5.1 \times 1 {0}^{- 19} )$$

of the previously reported method, which can significantly reduce the computation burden. For more complex surfaces, such as the human face shown in FIG. 5F, where n exceeds 1000, the decrease in computational requirements and processing time becomes even more significant.

Besides, it is noteworthy that the machine learning-based method has the potential to optimize the design of magnetic soft materials with complex 3D ferromagnetic domains. However, it requires a substantial amount of data for training, which is typically obtained through complex finite element calculations. This reliance leads to challenges such as difficulties in acquiring datasets and lengthy computation times. To illustrate the complexity and time consumption associated with machine learning methods, the design process of a simple ferromagnetic beam was examined as an example. The machine learning-based analysis is presented in the subsequent paragraphs, which indicates that the time required for calculation and optimization of simplified 1D problem is about 16 minutes. Furthermore, for more complicated 3D curved surface problems, the time cost will increase significantly. In contrast, the time required to process 3D curved surfaces in our approach typically ranges from 3 seconds to 5 minutes, indicating the remarkable reduction in computation burden.

Here, the inverse design for 1D ferromagnetic beams with 2D target shape changes using a machine learning-evolutionary algorithm is presented (FIGS. 14A to 14C). A ferromagnetic beam whose left end is fixed is considered. The beam is composed of 10 voxels in x (length) direction, each assigned with one of eight ferromagnetic orientations. Under an external magnetic field, the ferromagnetic domains are actuated accordingly, resulting in a shape change.

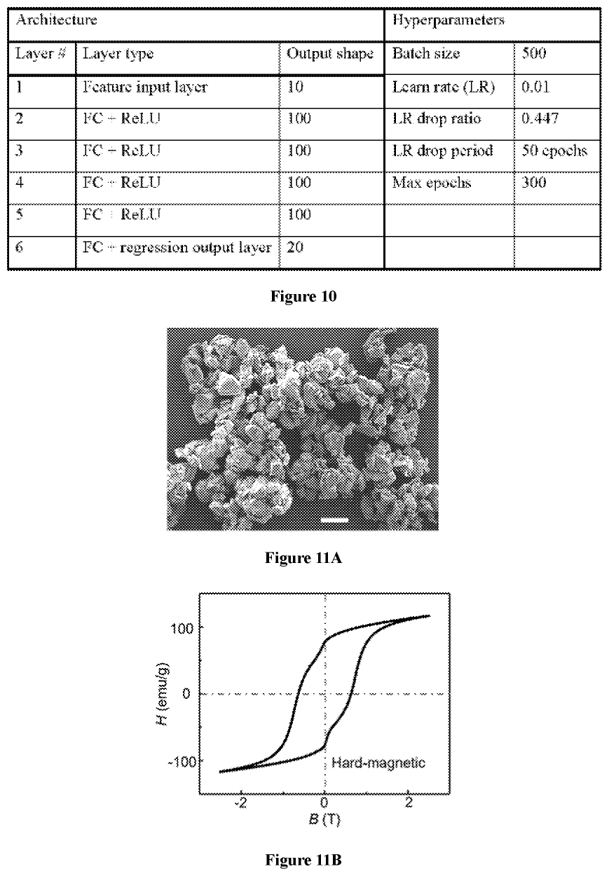

To generate a dataset for the machine learning model, 100,000 random ferromagnetic designs in terms of ferromagnetic orientations are created and the corresponding morphed shapes in terms of coordinates x and y are calculated using the finite difference method. The generated dataset thus consists of 100,000 design-shape pairs, which are split into training and validation datasets with fractions of 80% and 20%, respectively. The training dataset is then fed into a neural network model. The neural network consists of a feature input layer, 4 fully connected layers, and an output layer. The architecture and relevant hyperparameters used for the training are summarized in FIG. 10. The implementation, training, and testing are conducted using MATLAB (2023a, MathWorks, Natick, MA).

After the training is completed, the performance of the neural network is tested via the remaining validation dataset. The neural network is combined with evolutionary algorithm for the inverse design. Details of evolutionary algorithm implementation are referred to⁵¹⁻⁵³. Using the machine learning-evolutionary algorithm, inverse designs of three kinds of target shapes are performed with the time cost of 16 minutes (FIG. 14C), where the optimized design shapes exhibit good agreements with the target shapes.

In summary, the inverse design strategy proposed in this invention for ferromagnetic soft materials effectively reduces the computational load, mainly through converting the conventional calculation problems dealing with the configurations of 3D-distributed ferromagnetic domains to the simplified modulation of photoexposure time. The computational burden is so significant that the previously reported other approaches can only realize the inverse design of 2D structures with in-plane magnetization profiles. In contrast, the approach in this invention is superior by processing a smaller parameter space, and possessing no dependence on the acquisition of a large dataset, which allows constructing ferromagnetic soft materials with 3D complex magnetization profiles necessary for various target 3D curved surfaces.

### Supplementary Note 5 Measurement of Material Parameters

A Flory-Rehner free energy function was adopted for the hydrogel material:

$$Formula ( 19 )$$

$$W = \frac{1}{2} NkT [ tr ( {F}^{T} F ) - 3 - 2 ln ( det F ) ] - \frac{kT}{v} [ ( det F - 1 ) ln \frac{det F}{det F - 1} + \frac{χ}{det F} ] - \frac{μ}{v} ( det F - 1 )$$

where W represents the free energy density. N, k, T, v, χ, and μ are the number of polymeric chains, Boltzmann constant, temperature, volume per molecule, enthalpy of mixing, and chemical potential, respectively. F is the deformation gradient.

The relationship between the nominal stress and deformation gradient can be derived:

$$σ = \frac{\partial W}{\partial F} \qquad Formula ( 20 )$$

$$Formula ( 21 )$$

$$σ = NKT [ F - {( {F}^{T} )}^{- 1} ] + \frac{k T}{v} {( {F}^{T} )}^{- 1} [ det F ln ( 1 - \frac{1}{det F} ) + 1 + \frac{χ}{det F} - \frac{μ}{k T} det F ]$$

When the hydrogel material experiences free-swelling, F=diag[λ₀ λ₀ λ₀] and inserting it into Formula (21), the following equation can be derived:

$$N v ( \frac{1}{{λ}_{0}} - \frac{1}{{λ}_{0}^{3}} ) + ln ( 1 - \frac{1}{{λ}_{0}^{3}} ) + \frac{1}{{λ}_{0}^{3}} + \frac{1}{{λ}_{0}^{6}} = 0 \qquad Formula ( 22 )$$

According to Formula (21), when a uniaxial compression is applied to the hydrogel material, the longitudinal and transverse deformation can be determined by Formulae (23) and (24).

$$N v ( {λ}_{1} - \frac{1}{{λ}_{1}} ) + {λ}_{2}^{2} ln ( 1 - \frac{1}{{λ}_{1} {λ}_{2}^{2}} ) + \frac{1}{{λ}_{1}} + \frac{χ}{{λ}_{1}^{2} {λ}_{2}^{2}} - \frac{μ}{k T} {λ}_{2}^{2} = \frac{v {σ}_{1}}{k T} \qquad Formula ( 23 )$$

$$Nv ( {λ}_{2} - \frac{1}{{λ}_{2}} ) + {λ}_{1} {λ}_{2} ln ( 1 - \frac{1}{{λ}_{1} {λ}_{2}^{2}} ) + \frac{1}{{λ}_{2}} + \frac{χ}{{λ}_{1} {λ}_{2}^{3}} - \frac{μ}{k T} {λ}_{1} {λ}_{2} = 0 \qquad Formula ( 24 )$$

Through the combination of Formulae (23) and (24), it could obtain that:

$${λ}_{2}^{2} = {λ}_{1}^{2} - \frac{v {σ}_{1}}{k T} \times \frac{{λ}_{1}}{N v} \qquad Formula ( 25 )$$

To avoid the singularity of the analysis, the free-swelling state of the hydrogel material is chosen as the reference state, as shown in Formulae (26) and (27).

$${σ}_{1} = {λ}_{0}^{2} {s}_{1} = - {λ}_{0}^{2} \frac{F}{π {r}^{2}} \qquad Formula ( 26 )$$

$${λ}_{1} = {λ}_{0} \times {λ}_{1}^{′} = {λ}_{0} \times \frac{h - δ}{h} \qquad Formula ( 27 )$$

F is the compression force applied to the hydrogel material. r, δ, and h are the radius, displacement and height of the hydrogel material.

Through the fitting of Formula (23), the value of Nv and χ can be obtained.

### Supplementary Note 6 Definition of the Magnetization Resolution of Ferromagnetic Soft Material

As illustrated in FIGS. 20A to 20D, a series of circular patterns with different diameters in a rectangular ferromagnetic soft material is used to verify our magnetization programming resolution. The photoexposure time of the circular pattern and other regions is set to 4 s and 25 s, respectively. Similarly, compared to the surrounding rectangular area, the circular pattern features a lower crosslinking density and a larger swelling ratio, thereby creating a localized raised area when the ferromagnetic soft material is put in a solvent (FIG. 20B). After magnetization and recovery to flat state, the magnetization profile in the circular area will differ significantly from that in the surrounding rectangular area (FIG. 20C). The magnetization profile is also horizontally scanned across the circular pattern as indicated by the green dashed line, and the corresponding M_{z} is recorded in FIG. 20D, indicating the successful magnetization programming of circular pattern in the ferromagnetic soft material. There are two points where M_{z} is zero, and the horizontal axes are assumed to be x₁ and x₂, respectively. The region between x₁ and x₂, where M_{z} value is positive, indicates magnetization programming area of the circular pattern. Hence, the distance L is defined as the characteristic length of the magnetization profile displayed by the magneto-optical sensor, as expressed by Formulae (28) and (29).

$${M}_{z} ( {x}_{1} ) = {M}_{z} ( {x}_{2} ) = 0 \qquad Formula ( 28 )$$

$$L = \vert {x}_{2} - {x}_{1} \vert \qquad Formula ( 29 )$$

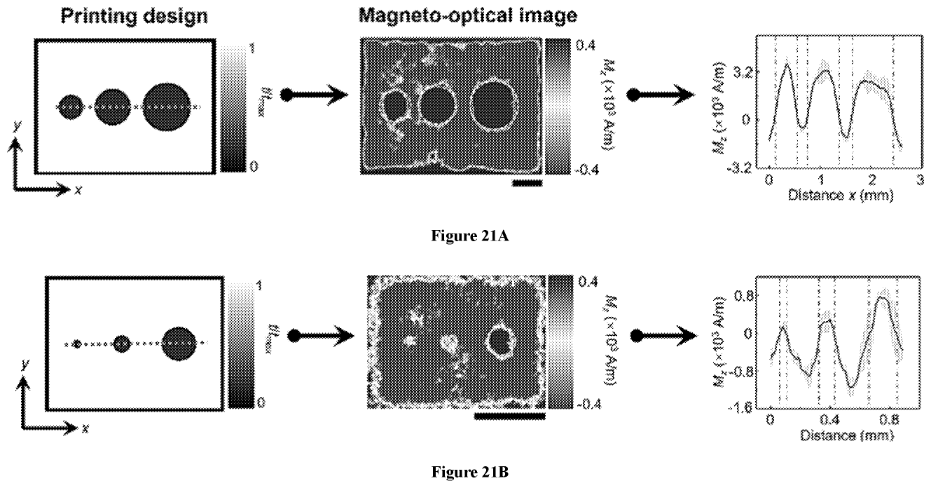

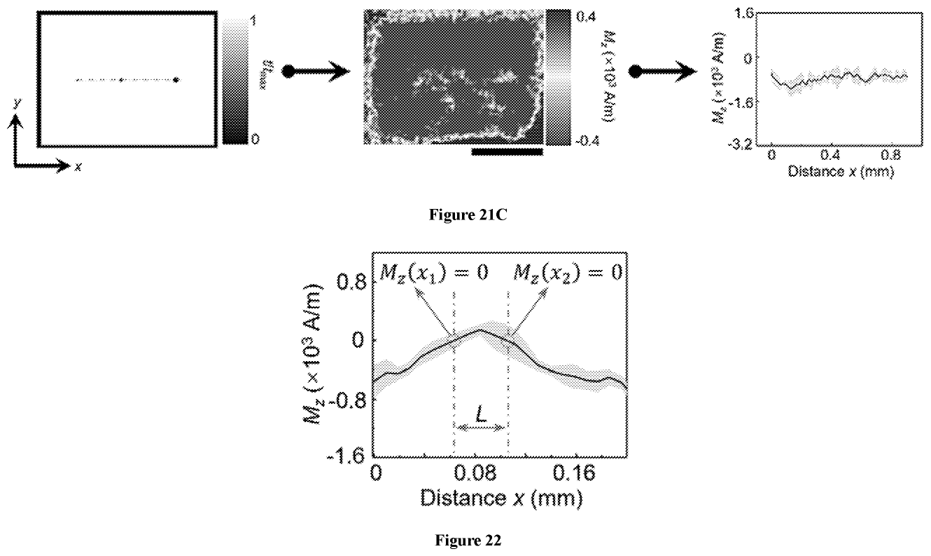

Furthermore, the diameters of the circular pattern are gradually changed (10, 20, 30, 50, 100, 200, 400, 600, and 800 km), and the resultant magnetization profiles are shown in FIGS. 21A to 21C. With the decrease in circular diameter, it can be found that the circular pattern with a diameter of 50 m can still be distinguished from the other regions in the magneto-optical image, while the smaller pattern cannot. The magnetization resolution is thus defined as the characteristic length of a minimum circular photoexposure pattern that can be detected by the magneto-optical sensor. The horizontal scanning result of the magnetization profile of 50 μm-diameter circular pattern is further shown in FIG. 22, and the corresponding L is ~45 μm. Therefore, the magnetization resolution of this invention is approximately 50 μm.

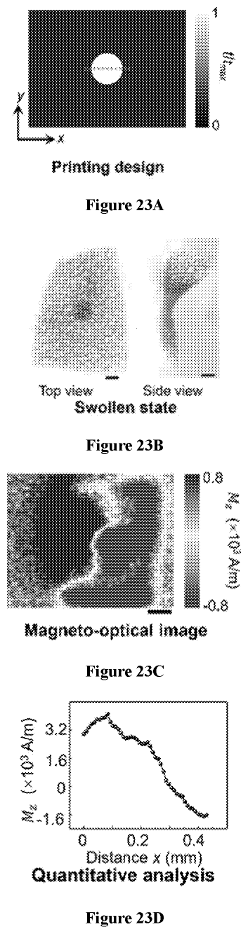

In the above experiments, the circular pattern experiences a lower photoexposure time compared to other regions, representing a negative resolution. In contrast, if defining the magnetization resolution in a positive manner, the circular pattern should have a relatively higher photoexposure time compared to other regions. For example, as shown in FIG. 23A, the photoexposure time of the circular pattern and other regions in a rectangular ferromagnetic soft material is set to 25 s and 4 s, respectively. However, at this moment, the region beyond the circle pattern swells significantly, leading to a complex global deformation FIG. 23B). Consequently, the magnetization profile becomes intricate and does not reflect the circular pattern (FIGS. 23C and 23D). Therefore, the positive definition method is not used in this invention.

In summary, the magnetization resolution in this invention refers to the characteristic size of a minimum circular photoexposure pattern that can be detected by the magneto-optical sensor.

### Supplementary Note 7 Formation of 3D-Distributed Ferromagnetic Domains

A polar decomposition is performed for the deformation gradient (F) of the hydrogel structure:

$$F = RU \qquad Formula ( 30 )$$

$$R = [ \begin{matrix}{R}_{u x} & {R}_{u y} & {R}_{u z} \\ {R}_{v x} & {R}_{v y} & {R}_{v z} \\ {R}_{w x} & {R}_{w y} & {R}_{w z}\end{matrix} ] \qquad Formula ( 31 )$$

R and U are rotation matrix and right stretch tensor, respectively. After magnetization, the relationship between the magnetization profiles in the deformed state (M) and recovery state (M′) can be determined by Formula (32).

$${M}^{′} = [ \begin{matrix}{M}_{u} \\ {M}_{v} \\ {M}_{w}\end{matrix} ] = \frac{{R}^{- 1}}{det {F}^{- 1}} M = \frac{{R}^{- 1}}{det {F}^{- 1}} [ \begin{matrix}{M}_{x} \\ {M}_{y} \\ {M}_{z}\end{matrix} ] \qquad Formula ( 32 )$$

Assuming that the direction of the pulsed magnetic field is along the Z axis during magnetization, we could obtain that:

$$[ \begin{matrix}{M}_{x} \\ {M}_{y} \\ {M}_{z}\end{matrix} ] = [ \begin{matrix}0 \\ 0 \\ 1\end{matrix} ] \qquad Formula ( 33 )$$

Therefore, the 3D-distributed ferromagnetic domains formed in the ferromagnetic soft materials can be quantitatively analyzed, as shown in FIGS. 25A to 25C, 26A and 26B.

### Supplementary Note 8 Feedback-Driven Compensation Process to Minimize the Deviation Between the Magnetic Actuation Shape and the Target Shape

In this invention, the swollen shape of ferromagnetic soft material can completely resemble the target shape in theory by modulating the spatial crosslinking density. However, when it comes to the magnetic actuation state, a deviation may occur between the actual actuation shape and the swollen shape. Increasing the strength of the actuating magnetic field and minimizing the storage of elastic potential energy (for instance, by lowering the material's modulus) in ferromagnetic soft materials may help the magnetic actuation shape to approach the swollen shape as far as possible. For example, the 3D curved deformations under magnetic actuation shown in this invention have been highly consistent with the swollen shape and target shape. While, the swelling deformations are nearly reached but not fully. Consequently, the target shape cannot be completely reproduced in the magnetically actuated ferromagnetic soft materials. In order to address this problem, a compensation scheme is planned to be introduced based on the feedback from the experimental results of magnetic actuation in the future, aiming to minimize the deviation between the magnetic actuation shape and the target shape (FIGS. 38, and 39A to 39G). The basic process of feedback-driven compensation is as follows:

Step 1: Perform the proposed inverse design method in this invention and print the ferromagnetic soft material according to the derived photoexposure time pattern. The printed material is put in a solvent and then magnetized at the swollen state, followed by the recovery to a flat state. Subsequently, ferromagnetic soft material is wirelessly actuated using a permanent magnet or electromagnetic coil system. A 3D digital microscope or micro-computed tomography (micro-CT) is then used to scan the deformation state, and the scanned point cloud data is processed to reconstruct the 3D surface under magnetic actuation.

Step 2: Compare the magnetic actuation state of ferromagnetic soft material with the target shape to calculate the experimental error, as shown in Formulae (34) and (35). Considering the target surface is discretized into n sub-regions, (xₑᵢ, yₑᵢ, zₑᵢ) and (xₜᵢ, yₜᵢ, zₜᵢ) represent the center coordinates of a sub-region i for the actual magnetic actuation surface and the target surface, respectively. ΔPᵢ denotes the center coordinate deviation of the sub-region i, and L is the characteristic length of the sub-region in the target surface. Finally, e represents the cumulative deviation between the actual and target surfaces.

$$Δ {P}_{i} = ( {x}_{ti} - {x}_{e i} , {y}_{ti} - {y}_{e i} , {z}_{ti} - {z}_{e i} ) \qquad Formula ( 34 )$$

$$e = \sum {e}_{i} = \sum \frac{\vert Δ {P}_{i} \vert}{L} \qquad Formula ( 35 )$$

Step 3: If the calculated cumulative deviation is less than the allowable deviation ec (this value can be preset according to the specific case of target shape), the current actuation state is accepted. If the cumulative deviation exceeds the allowable range, adjustments (step 4) are made based on the feedback of the coordinate deviation.

Step 4: Adjust the swollen state of the ferromagnetic soft material for magnetization according to Formulae (36) to (38). Let (xᵣᵢ, yᵣᵢ, zᵣᵢ) represent the center coordinate of the sub-region in the revised magnetization state, and k denotes the correction coefficient.

$${x}_{r i} = {x}_{ti} + k ( {x}_{ti} - {x}_{e i} ) \qquad Formula ( 36 )$$

$${y}_{r i} = {y}_{ti} + k ( {y}_{ti} - {y}_{e i} ) \qquad Formula ( 37 )$$

$${z}_{r i} = {z}_{ti} + k ( {z}_{ti} - {z}_{e i} ) \qquad Formula ( 38 )$$

Step 5: Re-conduct the inverse design based on the revised swollen shape for magnetization, and obtain the modified photoexposure time pattern. Return to Step 1 and print ferromagnetic soft material to update the magnetic actuation shape.

To verify the feasibility of the proposed feedback-driven error compensation scheme, a semicircular target shape is used as an example (FIGS. 39A to 39G). When the corresponding printed ferromagnetic soft material is magnetized at the swollen state (the swollen shape is same with the target shape), its magnetization profile along the central axis is illustrated in FIG. 39B. Through FEA analysis, the magnetic actuation shape of the ferromagnetic soft material is obtained as shown in FIG. 39C. A comparison with the target shape reveals the deviation between the magnetic actuation shape and the target shape, which increases towards the ends of the structure. The corresponding error analysis results are shown in FIG. 39D. To reduce this error, the swollen shape is compensated and corrected according to Formulae (36) to (38), with the correction coefficient set to 1. Consequently, the revised swollen state is depicted in FIG. 39E. When the ferromagnetic soft material is magnetized at this revised state, it is derived that the error in the magnetic actuation shape is significantly reduced (with the cumulative error decreasing by 35% in FIG. 39F), and the consistency between the magnetic actuation shape and the target shape is guaranteed (FIG. 39G).

### REFERENCES

1. Ijspeert, A. J. Biorobotics: using robots to emulate and investigate agile locomotion. Science 346, 196-203 (2014).
2. Park, S.-J. et al. Phototactic guidance of a tissue-engineered soft-robotic ray. Science 353, 158-162 (2016).
3. Sydney Gladman, A., Matsumoto, E. A., Nuzzo, R. G., Mahadevan, L. & Lewis, J. A. Biomimetic 4D printing. Nat. Mater. 15, 413-418 (2016).
4. Armon, S., Efrati, E., Kupferman, R. & Sharon, E. Geometry and mechanics in the opening of chiral seed pods. Science 333, 1726-1730 (2011).
5. Kuchen, E. E. et al. Generation of leaf shape through early patterns of growth and tissue polarity. Science 335, 1092-1096 (2012).
6. Cheng, X. et al. Programming 3D curved mesosurfaces using microlattice designs. Science 379, 1225-1232 (2023).
7. Han, M. et al. Catheter-integrated soft multilayer electronic arrays for multiplexed sensing and actuation during cardiac surgery. Nat. Biomed. Eng. 4, 997-1009 (2020).
8. Han, M. et al. Submillimeter-scale multimaterial terrestrial robots. Sci. Robot. 7, eabn0602 (2022).
9. Kim, Y, Yuk, H., Zhao, R., Chester, S. A. & Zhao, X. Printing ferromagnetic domains for untethered fast-transforming soft materials. Nature 558, 274-279 (2018).
10. Zhang, C. et al. Wirelessly powered deformable electronic stent for noninvasive electrical stimulation of lower esophageal sphincter. Sci. Adv. 9, eade8622 (2023).
11. Fischer, R. S. et al. Contractility, focal adhesion orientation, and stress fiber orientation drive cancer cell polarity and migration along wavy ECM substrates. Proc. Natl Acad. Sci. USA 118, e2021135118 (2021).
12. Choi, Y-J. et al. Muscle-derived extracellular matrix on sinusoidal wavy surfaces synergistically promotes myogenic differentiation and maturation. J. Mater Chem. B 6, 5530-5539 (2018).
13. Xue, Z. et al. Assembly of complex 3D structures and electronics on curved surfaces. Sci. Adv. 8, eabm6922 (2022).
14. Kim, B. H. et al. Three-dimensional electronic microfliers inspired by wind-dispersed seeds. Nature 597, 503-510 (2021).
15. Siefert, E., Reyssat, E., Bico, J. & Roman, B. Bio-inspired pneumatic shape-morphing elastomers. Nat. Mater. 18, 24-28 (2019).
16. Huang, T.-Y et al. Four-dimensional micro-building blocks. Sci. Adv. 6, eaav8219 (2020).
17. Jin, D. et al. Four-dimensional direct laser writing of reconfigurable compound micromachines. Mater. Today 32, 19-25 (2020).
18. Xu, T., Zhang, J., Salehizadeh, M., Onaizah, O. & Diller, E. Millimeter-scale flexible robots with programmable three-dimensional magnetization and motions. Sci. Robot. 4, eaav4494 (2019).
19. Zhang, J. et al. Voxelated three-dimensional miniature magnetic soft machines via multimaterial heterogeneous assembly. Sci. Robot. 6, eabf0112 (2021).
20. Dong, Y et al. Untethered small-scale magnetic soft robot with programmable magnetization and integrated multifunctional modules. Sci. Adv. 8, eabn8932 (2022).
21. Xia, N. et al. Dynamic morphological transformations in soft architected materials via buckling instability encoded heterogeneous magnetization. Nat. Commun. 13, 7514 (2022).
22. Nojoomi, A., Jeon, J. & Yum, K. 2D material programming for 3D shaping. Nat. Commun. 12, 603 (2021).
23. Bo, R., Xu, S., Yang, Y & Zhang, Y Mechanically-guided 3D assembly for architected flexible electronics. Chem. Rev. 123, 11137-11189 (2023).
24. Pikul, J. H. et al. Stretchable surfaces with programmable 3D texture morphing for synthetic camouflaging skins. Science 358, 210-214 (2017).
25. Gao, T., Bico, J. & Roman, B. Pneumatic cells toward absolute Gaussian morphing. Science 381, 862-867 (2023).
26. Sawhney, R. & Crane, K. Boundary first flattening. ACM Trans. Graph. 37, 1-14 (2017).
27. Sun, X. et al. Machine learning-enabled forward prediction and inverse design of 4D-printed active plates. Nat. Commun. 15, 5509 (2024).
28. Bai, Y et al. A dynamically reprogrammable surface with self-evolving shape morphing. Nature 609, 701-708 (2022).
29. Hajiesmaili, E., Larson, N. M., Lewis, J. A. & Clarke, D. R. Programmed shape-morphing into complex target shapes using architected dielectric elastomer actuators. Sci. Adv. 8, eabn9198 (2022).
30. Nojoomi, A., Arslan, H., Lee, K. & Yum, K. Bioinspired 3D structures with programmable morphologies and motions. Nat. Commun. 9, 3705 (2018).
31. Alapan, Y, Karacakol, A. C., Guzelhan, S. N., Isik, I. & Sitti, M. Reprogrammable shape morphing of magnetic soft machines. Sci. Adv. 6, eabc6414 (2020).
32. Cui, J. et al. Nanomagnetic encoding of shape-morphing micromachines. Nature 575, 164-168 (2019).
33. Xia, N. et al. Decoupling and reprogramming the wiggling motion of midge larvae using a soft robotic platform. Adv. Mater. 34, 2109126 (2022).
34. Sun, M. et al. Exploiting ferrofluidic wetting for miniature soft machines. Nat. Commun. 13, 7919 (2022).
35. Kim, Y & Zhao, X. Magnetic soft materials and robots. Chem. Rev. 122, 5317-5364 (2022).
36. Sun, M. et al. Reconfigurable magnetic slime robot: deformation, adaptability, and multifunction. Adv. Funct. Mater. 32, 2112508 (2022).
37. Hu, W., Lum, G. Z., Mastrangeli, M. & Sitti, M. Small-scale soft-bodied robot with multimodal locomotion. Nature 554, 81-85 (2018).
38. Ju, Y et al. Reconfigurable magnetic soft robots with multimodal locomotion. Nano Energy 87, 106169 (2021).
39. Lum, G. Z. et al. Shape-programmable magnetic soft matter. Proc. Natl Acad. Sci. USA 113, E6007-E6015 (2016).
40. Kokkinis, D., Schaffner, M. & Studart, A. R. Multimaterial magnetically assisted 3D printing of composite materials. Nat. Commun. 6, 8643 (2015).
41. Deng, H. et al. Laser reprogramming magnetic anisotropy in soft composites for reconfigurable 3D shaping. Nat. Commun. 11, 6325 (2020).
42. Hu, X. et al. Magnetic soft micromachines made of linked microactuator networks. Sci. Adv. 7, eabe8436 (2021).
43. Zhang, S. et al. 3D-printed micrometer-scale wireless magnetic cilia with metachronal programmability. Sci. Adv. 9, eadf9462 (2023).
44. Liu, Z. et al. Creating three-dimensional magnetic functional microdevices via molding-integrated direct laser writing. Nat. Commun. 13, 2016 (2022).
45. Sun, Y et al. A 3D-printed ferromagnetic liquid crystal elastomer with programmed dual-anisotropy and multi-responsiveness. Adv. Mater. 35, 2302824 (2023).
46. Li, Z., Lai, Y P. & Diller, E. 3D printing of multilayer magnetic miniature soft robots with programmable magnetization. Adv. Intell. Syst. 6, 2300052 (2024).
47. Kim, Y, Yuk, H., Zhao, R., Chester, S. A. & Zhao, X. Printing ferromagnetic domains for untethered fast-transforming soft materials. Nature 558, 274-279 (2018).
48. Xu, T., Zhang, J., Salehizadeh, M., Onaizah, O. & Diller, E. Millimeter-scale flexible robots with programmable three-dimensional magnetization and motions. Sci. Robot. 4, eaav4494 (2019).
49. Zhao, Z. & Zhang, X. S. Topology optimization of hard-magnetic soft materials. J. Mech. Phys. Solids. 158, 104628 (2022).
50. Ma, C., Chang, Y, Wu, S. & Zhao, R. R. Deep learning-accelerated designs of tunable magneto-mechanical metamaterials. ACS Appl. Mater Interfaces. 14, 33892-33902 (2022).
51. Sun, X. et al. Machine learning-enabled forward prediction and inverse design of 4D-printed active plates. Nat. Commun. 15, 5509 (2024).
52. Sun, X. et al. Machine Learning-Evolutionary Algorithm Enabled Design for 4D-Printed Active Composite Structures. Adv. Funct. Mater. 32, 2109805 (2022).
53. Wang, L. et al. Evolutionary design of magnetic soft continuum robots. Proc. Natl Acad. Sci. USA 118, e2021922118 (2021).
54. Hu, W., Lum, G. Z., Mastrangeli, M. & Sitti, M. Small-scale soft-bodied robot with multimodal locomotion. Nature 554, 81-85 (2018).
55. Lum, G. Z. et al. Shape-programmable magnetic soft matter. Proc. Natl Acad. Sci. USA 113, E6007-E6015 (2016).
56. Cui, J. et al. Nanomagnetic encoding of shape-morphing micromachines. Nature 575, 164-168 (2019).
57. Alapan, Y, Karacakol, A. C., Guzelhan, S. N., Isik, I. & Sitti, M. Reprogrammable shape morphing of magnetic soft machines. Sci. Adv. 6, eabc6414 (2020).
58. Zhang, J. et al. Voxelated three-dimensional miniature magnetic soft machines via multimaterial heterogeneous assembly. Sci. Robot. 6, eabf0112 (2021).
59. Zhao, R., Kim, Y, Chester, S. A., Sharma, P. & Zhao, X. Mechanics of hard-magnetic soft materials. J. Mech. Phys. Solids. 124, 244-263 (2019).
60. Wang, J., Wang, D., Dong, L., Zhang, M. & Gu, G. Analytical modeling and inverse design of centimeter-scale hard-magnetic soft robots. IEEE Trans. Autom. Sci. Eng. (2023). DOI: 10.1109/TASE.2023.3313395.
61. Hu, X. et al. Magnetic soft micromachines made of linked microactuator networks. Sci. Adv. 7, eabe8436 (2021).
62. Dong, Y et al. Untethered small-scale magnetic soft robot with programmable magnetization and integrated multifunctional modules. Sci. Adv. 8, eabn8932 (2022).
63. Sun, Y et al. A 3D-Printed Ferromagnetic Liquid Crystal Elastomer with Programmed Dual-Anisotropy and Multi-Responsiveness. Adv. Mater. 35, 2302824 (2023).
64. Zhang, S. et al. 3D-printed micrometer-scale wireless magnetic cilia with metachronal programmability. Sci. Adv. 9, eadf9462 (2023).
65. Liu, Z. et al. Creating three-dimensional magnetic functional microdevices via molding-integrated direct laser writing. Nat. Commun. 13, 2016 (2022).
66. Li, Z., Lai, Y P. & Diller, E. 3D printing of multilayer magnetic miniature soft robots with programmable magnetization. Adv. Intell. Syst. 6, 2300052 (2024).
67. Xia, N. et al. Decoupling and reprogramming the wiggling motion of midge larvae using a soft robotic platform. Adv. Mater. 34, 2109126 (2022).
68. Ju, Y et al. Reconfigurable magnetic soft robots with multimodal locomotion. Nano Energy 87, 106169 (2021).

What is claimed is:

1. A ferromagnetic material, comprising:
a. A hydrogel network comprising a pre-determined crosslinking density such that said hydrogel network can morph between a normal state and a second state, wherein said second state comprises a pre-determined shape resulting from said pre-determined crosslinking density; and
b. Ferromagnetic particles entangled in said hydrogel network, wherein said ferromagnetic particles form uniformly oriented ferromagnetic domains in said second state;
wherein said ferromagnetic material morphs from said normal state to said second state due to dipolar interaction when subjected to a suitable magnetic field.

2. The ferromagnetic material of claim 1, wherein said pre-determined crosslinking density is formed by photodosage-based printing.

3. The ferromagnetic material of claim 1, wherein said hydrogel network comprises polymer chains with amino groups and/or carboxylic groups.

4. The ferromagnetic material of claim 1, wherein said hydrogel network is formed from one or more monomers selected from the group consisting of chitosan, acrylic acid, methacrylic acid, and N-isopropylacrylamide.

5. The ferromagnetic material of claim 1, wherein said second state is achieved by immersing said hydrogel network in a solvent.

6. The ferromagnetic material of claim 1, wherein said ferromagnetic particles are one or more selected from the group consisting of chromium oxide (CrO₂), barium ferrite, and NdFeB@SiO₂.

7. The ferromagnetic material of claim 1, wherein said second state comprises a 3D surface.

8. The ferromagnetic material of claim 1, wherein said ferromagnetic material comprises a portion with microlattice design.

9. The ferromagnetic material of claim 1, wherein said normal state is a 2D film.

10. A device for information storage, comprising said ferromagnetic material of claim 1.

11. A soft robot, comprising said ferromagnetic material of claim 1.

12. The soft robot of claim 11, wherein movement of said soft robot is induced by exposing to an external magnetic field to cause said ferromagnetic material to morph between said normal state and said second state.

13. A medical patch, comprising said ferromagnetic material of claim 1.

14. The medical patch of claim 13, wherein said pre-determined shape is a shape adopted for covering a biological surface.

15. The medical patch of claim 13, wherein said hydrogel matrix is loaded with a drug to be released.

16. A method for making said ferromagnetic material of claim 1, comprising the steps of:
a. Providing a mixture of unmagnetized ferromagnetic particles and precursors of said hydrogel matrix;
b. Determining a crosslinking pattern to achieve said pre-determined shape based on swelling behavior and crosslinking density of said ferromagnetic material;
c. Crosslinking said mixture according to said crosslinking pattern to form an unmagnetized hydrogel network with said pre-determined crosslinking density in said normal state;
d. Immersing said unmagnetized hydrogel network in a solvent to convert into said second state; and
e. Magnetizing said unmagnetized hydrogel network to achieve uniformly oriented ferromagnetic domains in said second state resulting in said ferromagnetic material.

17. The method of claim 16, wherein said crosslinking pattern is an exposure pattern for photodosage-based printing.

18. The method of claim 16, wherein said step (b) comprises the steps of:
i. Obtaining 3D information of said pre-determined shape;
ii. Discretizing said 3D information using a 3D mesh;
iii. Flattening said 3D mesh into a 2D mesh through conformal mapping and obtaining a deformation gradient between said 3D mesh and 2D mesh; and
iv. Determining said crosslinking pattern from said deformation gradient based on a determined relationship between swelling behavior and crosslinking density of the ferromagnetic material.

19. The method of claim 16, wherein said step (e) comprises exposing said unmagnetized hydrogel network to a pulsed magnetic field.

20. The method of claim 16, wherein said 3D mesh and said 2D mesh are triangular meshes.
